(19) United States
(12) Patent Application Publication
(10) Pub. No.: US 2021/0255132 A1
(43) Pub. Date: Aug. 19, 2021

(54) SUPER SENSITIVE SENSOR FOR THE DETECTION OF HYDROXYL FREE RADICALS WITH SCAVENGING PROPERTIES

(71) Applicant: The University of Toledo, Toledo, OH (US)

(72) Inventors: Ana C. Alba Rubio, Toledo, OH (US); Dong-Shik Kim, Toledo, OH (US); Surachet Duanghathaipornsuk, Toledo, OH (US)

(73) Assignee: The University of Toledo, Toledo, OH (US)

(21) Appl. No.: 17/178,455

(22) Filed: Feb. 18, 2021

Related U.S. Application Data
(60) Provisional application No. 62/977,945, filed on Feb. 18, 2020.

(51) Int. Cl. G01N 27/30; B01D 69/02; B01D 69/14; B01D 71/02; H01M 8/1051; H01M 8/0662

(52) U.S. Cl. CPC G01N 27/308; B01D 69/02; B01D 69/148; H01M 2008/1095; H01M 8/1051; H01M 8/0687; B01D 71/024

(57) ABSTRACT

Compositions, devices, and methods for sensing free radicals such as hydroxyl radicals, involving cerium oxide nanoparticles on a carbon-based substrate, are described.

### RELATED APPLICATION

This application claims priority to U.S. Provisional Application No. 62/977,945 filed under 35 U.S.C. § 111(b) on Feb. 18, 2020, the disclosure of which is incorporated herein by reference in its entirety.

### STATEMENT REGARDING FEDERALLY SPONSORED RESEARCH

This invention was made with government support under Grant Number 1817294 awarded by the National Science Foundation. The government has certain rights in this invention.

### BACKGROUND

Reactive oxygen species (ROS) are well known for their extreme reactivity. Due to their significant impact on different industries, environment, and human health, ROS have been extensively studied in chemical, biological, environmental, and medical research fields. While free radicals are used beneficially in biological and environmental systems, they can be detrimental to membrane separations, cellular metabolisms, and aggravation of air pollution. As an example, hydroxyl radicals react with functional groups in the ionomers that constitute the polymer electrolyte membranes (PEM) used in fuel cells, and as a result, the PEM thickness is reduced, generating local pinholes that release hydrofluoric acid and sulfuric acid. This increased passing of reactant gases through the PEM finally leads to fuel cell failure.

Free radicals, which have an unpaired electron in the outer electron shell, are found both inside and outside human cells. They are necessary for cells to properly maintain their functions, including the cellular responses and immune functions such as activating the heme oxygenase and the transcription factor nuclear factor-kappa B (NF-κB), eliminating bacteria, and inactivating viruses. However, a proper level of production of free radicals is the key to the maintenance of their advantages as their overproduction may lead to irreversible cell damage. Among all free radicals, the hydroxyl radical (●OH) is the most reactive and dangerous, with a short lifetime of nanoseconds. Hydroxyl radicals (●OH) can also be generated inside cells, at mitochondria, human blood, and interstitial fluid.

The impact of free radicals on medical and clinical fields is just as critical. The hydroxyl radical (●OH) may be used as a biomarker to indicate aging, cancer, Alzheimer's, and Parkinson's diseases. Various detecting techniques have been used to investigate the relationship between ●OH radicals and the symptoms of these diseases, and an electrochemical method has been proven to be easy, fast, practical, and inexpensive, although the sensitivity and selectivity of electrochemical sensors with ●OH radicals still have room to improve. As the medical community becomes proactive in prevention rather than treatment, this approach has proven to be successful in decreasing the incidence and fatality of serious and chronic diseases. Common to diseases such as Alzheimer's, Parkinson's, and multiple sclerosis is the abnormally large production of ROS due to altered cellular metabolism from the onset of disease. Because certain types of free radicals are known to cause or exacerbate illnesses such as cancer, tumor, and neurodegenerative diseases, detection and identification of free radicals is important to diagnosing and treating the diseases. Hospital labs, chemical testing labs, and biochemical technology companies routinely run free radical measurements on various blood, body fluids, and tissue samples in vivo or in vitro. Therefore, measurements of reactive oxygen species (ROS, or free radicals) are frequently practiced in a very broad range of industrial, environmental, medical, and clinical research including cell biology, pathology, hematology, immunology, oncology, and radiology.

In environmental applications, free radicals can be beneficially used in advanced oxidation processes. For example, free radicals can be used to remediate contaminated water or soil using hydroxyl radicals produced from the reaction between hydrogen peroxide and UV light. However, the production rate of hydroxyl radicals should be well controlled for efficient operation. Thus, a real-time and reusable monitoring system for ●OH radicals would be advantageous.

Currently, different strategies are used to detect the type and concentration of intracellular and intercellular ROS. In general, these strategies use either free radical trapping or fingerprinting methods. In free radical trapping methods, trap molecules such as dimethylpyrroline-N-oxide (DMPO) and α-phenyl-tert-butylnitrone (PBN) are used to trap free radicals, and then electron spin resonance (ESR), also called electron paramagnetic resonance (EPR), is used to measure the concentration of radical trapping molecules. This is only a direct method to measure free radicals, but it is known to be too insensitive to detect superoxide (●O₂⁻) and hydroxyl (●OH) radicals. Trap molecules often perturb the system under investigation, as trapping free radicals results in decreasing damage of those biological systems. Moreover, they are sometimes rapidly metabolized or oxidized in vivo, resulting in inaccurate measurements. Other common indirect methods practiced in many research labs include measuring the damage that free radicals cause, known as oxidative damage biomarkers. For example, 2-deoxyribose, a component of DNA, is easily decomposed by hydroxyl radicals. Therefore, radical concentration can be estimated by measuring the byproduct of the reaction between deoxyribose and ●OH radicals. 2,2′-azino-bis(3-ethylbenzothiazoline-6-sulphonic acid) (ABTS) is a molecule that is easily oxidized by hydroxyl or superoxide radicals with high affinity, and upon reaction, changes color, which can be read by a spectrometer. Another common biomarker is glutathione, a tripeptide that defends important cellular components from free radicals. However, these fingerprinting methods are time-consuming and labor-intensive. Additionally, these biomarkers are susceptible to other reactions with various chemicals and free radicals. For example, the biological method using glutathione is costly and includes materials that degrade easily, which prevents it from being reused multiple times.

For the electrochemical interaction with free radicals, both biological and inorganic molecules have been used for surface modification of electrodes to enhance the sensitivity and selectivity of sensors for the detection of free radicals. However, the use of biological molecules faces the downside of the denaturation and instability at certain pHs and temperatures, resulting in a decreased sensor performance. To overcome these challenges, inorganic materials with enzyme mimetic properties such as gold nanoparticles and silver nanoparticles have been used for the detection of free radicals. However, inorganic elements have been scarcely used for the detection of ●OH radicals in electrochemical methods.

Cerium oxide is a scavenger for ●OH radicals. Cerium oxide nanoparticles (CeNPs) demonstrate effective scavenging of ●OH radicals due to their superoxide dismutase mimetic activity. Until now, CeNPs have been actively used for eliminating ●OH radicals from damaged cells induced by the oxidative stress. For example, CeNPs have been injected into a culture of primary mouse fibroblasts in vitro and it was found that they reduced the level of ●OH radicals. CeNPs were also able to increase the survival rate of mice exposed to x-ray radiation by 60%. Another set of studies showed that CeNPs protected 99% of normal cells from the radiation-induced free radicals that caused cell death. However, current technology using CeNPs is not sensitive enough to detect hydroxyl radicals due to their lack of conductivity.

In sum, current technology for detecting free radicals include assay kits using colorimetric methods, metal oxidation methods, and electromagnetic spin resonance (ESR) or electro paramagnetic resonance (EPR), and these are inaccurate, inconsistent, time-consuming, or expensive. Furthermore, these methods cannot perform real-time detection, and cannot detect at a concentration lower than 1 mM. Thus, there is a need in the art for new and improved compositions and methods for sensing or scavenging free radicals such as hydroxyl radicals.

### SUMMARY

Provided is a composition comprising a carbon-based substrate and cerium oxide nanoparticles on the carbon-based substrate, wherein the carbon-based substrate comprises a conductive, amorphous carbon.

In certain embodiments, the cerium oxide nanoparticles are present in an amount ranging from about 1% by weight to about 60% by weight. In certain embodiments, the cerium oxide nanoparticles are present in an amount ranging from about 2% by weight to about 30% by weight. In certain embodiments, the cerium oxide nanoparticles are present in an amount ranging from about 3% by weight to about 15% by weight.

In certain embodiments, the conductive, amorphous carbon comprises carbon black. In certain embodiments, the conductive, amorphous carbon comprises a functionalized surface. In particular embodiments, the functionalized surface comprises carboxyl groups. In certain embodiments, the carbon-based substrate does not include graphene or graphene oxide. In certain embodiments, the carbon-based substrate consists of the conductive, amorphous carbon.

In certain embodiments, the cerium oxide nanoparticles have an average size of about 1 nm. In certain embodiments, the nanoparticles have an average size of about 2 nm. In certain embodiments, the nanoparticles have an average size of about 3 nm.

In certain embodiments, the cerium oxide nanoparticles are chemically bonded to the carbon-based substrate. In certain embodiments, the cerium oxide nanoparticles are directly on the carbon-based substrate.

In certain embodiments, the cerium oxide nanoparticles comprise a ratio of Ce³⁺ to Ce⁴⁺ of at least 30:70. In certain embodiments, the cerium oxide nanoparticles comprise a ratio of Ce³⁺ to Ce⁴⁺ of at least 40:60. In certain embodiments, the cerium oxide nanoparticles comprise a ratio of Ce³⁺ to Ce⁴⁺ of at least 50:50.

In certain embodiments, the composition does not include Prussian blue.

Further provided is a filter for scavenging radicals comprising the composition. In certain embodiments, the composition is embedded within a membrane. In certain embodiments, the membrane is a polymer electrolyte membrane (PEM). In certain embodiments, the membrane comprises polytetrafluoroethylene, polytetrafluoroethylene-chlorotrifluoro, ethylene copolymer, polychlorotrifluoroethylene, polybromotrifluoroethylene, polytetrafluoroethylene-bromotrifluoroethylene copolymer, polytetrafluoroethylene-perfluorovinyl ether copolymer, polytetrafluoroethylene-hexafluoropropylene, or copolymers thereof.

Further provided is a sensor comprising an electrode, a carbon substrate on the electrode, and cerium oxide nanoparticles directly on the carbon substrate, wherein the cerium oxide nanoparticles comprise a ratio of cerium (III) to cerium (IV) of at least 0.4.

In certain embodiments, the cerium nanoparticles have an average size ranging from about 0.3 nm to about 2 nm. In certain embodiments, the cerium oxide nanoparticles have an average size ranging from about 1 nm to about 2 nm. In certain embodiments, the cerium oxide nanoparticles have an average size of about 0.3 nm.

In certain embodiments, the electrode comprises a metal or glassy carbon.

In certain embodiments, the carbon substrate comprises graphene or graphene oxide. In certain embodiments, the carbon substrate consists of graphene or graphene oxide. In particular embodiments, the sensor comprises a cerium oxide nanoparticles loading ranging from about 10 to about 90 wt %. In particular embodiments, the sensor comprises a cerium oxide nanoparticles loading of about 25 wt %. In particular embodiments, the sensor comprises a cerium oxide nanoparticles loading of about 50 wt %. In particular embodiments, the sensor comprises a cerium oxide nanoparticles loading of about 75 wt %.

In certain embodiments, the carbon substrate comprises a conductive, amorphous carbon. In certain embodiments, the carbon substrate consists of a conductive, amorphous carbon. In certain embodiments, the sensor does not include Prussian blue.

Further provided is a sensor comprising an elongated body having a proximal end and a distal end; a sensing area at the distal end, wherein the sensing area comprises a working electrode and a counter electrode, wherein the working electrode comprises a sensing composition configured to detect free radicals; at least two curved ridges extending a distance beyond the elongated body to at least partially encircle the sensing area; and an opening between the at least two curved ridges, wherein the opening is configured to permit a fluid to flow into the sensing area while the curved ridges are contacting a surface.

In certain embodiments, the sensing composition comprises cerium oxide nanoparticles deposited on a carbon-based substrate. In particular embodiments, the carbon-based substrate comprises a conductive, amorphous carbon. In particular embodiments, the carbon-based substrate consists of a conductive, amorphous carbon. In particular embodiments, the carbon-based substrate comprises graphene or graphene oxide. In particular embodiments, the carbon-based substrate consists of graphene or graphene oxide.

In certain embodiments, the cerium oxide nanoparticles have an average size of less than 5 nm.

Further provided is a method for scavenging radicals, the method comprising detecting free radicals with a sensing composition comprising cerium oxide nanoparticles on a carbon-based substrate, wherein the carbon-based substrate comprises a conductive, amorphous carbon. In certain embodiments, the cerium oxide nanoparticles are directly on the carbon-based substrate. In certain embodiments, the sensing composition does not include Prussian blue. In certain embodiments, the free radicals are hydroxyl radicals. In certain embodiments, the free radicals are detected at a detection limit of about 0.006 mM.

Further provided is a method for making a free radical sensing composition, the method comprising acid-treating a conductive, amorphous carbon to create a functionalized surface on acid-treated amorphous carbon; contacting the functionalized surface with a solution comprising a cerium organometallic precursor to graft the cerium precursor onto the functionalized surface and create a grafted surface (surface organometallic grafting method, SOG); removing solvent from the grafted surface; performing a thermal treatment in inert atmosphere to produce a product; drying the product to produce a free radical sensing composition; and conducting a thermal treatment in inert to remove the precursor ligands. In certain embodiments, the cerium precursor comprises tris(cyclopentadienyl)cerium(III). In certain embodiments, the method further comprises drying the acid-treated amorphous carbon under vacuum prior to contacting the functionalized surface with the solution. In certain embodiments, the contacting is conducted in an inert atmosphere. In certain embodiments, the solvent comprises tetrahydrofuran (THF).

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1: The redox reaction of CeNPs with ●OH radicals.

FIG. 2: Cyclic voltammogram showing a bare sensor vs. sensor modified with a 1.2 wt % CeNPs/GO-SOG composite, where GO represents graphene oxide and SOG stands for surface organometallic grafting.

FIG. 3: Cyclic voltammogram showing the stability of the 1.2 wt % CeNPs/GO-SOG composite on the sensor surface after different cycles in electrolyte solution, where GO means graphene oxide and SOG means surface organometallic grafting.

FIGS. 4A-4B: Cyclic voltammograms showing the selectivity of the 1.2 wt % CeNPs/GO-SOG sensor to OH radicals, where GO means graphene oxide and SOR means surface organometallic grafting. FIG. 4B shows the same CV graph seen in FIG. 4A except annotated to illustrate the detection of hydroxyl radicals and H₂O₂.

FIG. 5: Bar graphs showing sensor responses vs. CeNPs loading (wt %) on CeNPs/GO-SOG composites, where GO stands for graphene oxide and SOG stands for surface organometallic grafting.

FIG. 6: Bar graphs showing normalized sensor responses/masses of CeNPs vs. CeNPs loading (wt %) on CeNPs/GO-SOG, where GO stands for graphene oxide and SOG stands for surface organometallic grafting.

FIGS. 7A-7B: Bar graphs showing sensor responses using different methods and supports. FIG. 7A shows sensor response using CeNPs/GO composites synthesized by different methods, where SOG stands for surface organometallic grafting and LTS stands for low-temperature solution. FIG. 7B shows composites synthesized by surface organometallic grafting (SOG) over two different supports: carbon (C) and graphene oxide (GO). FIGS. 7A-7B include the result from a Prussian blue-containing sensor.

FIGS. 8A-8D: Illustrations of non-limiting example sensors for free radical detection. FIG. 8A shows a perspective view of a sensor with a probe tip. FIG. 8B shows a perspective view of a sensor without a probe tip. FIG. 8C shows a side view of a sensor without a probe tip. FIG. 8D shows a bottom view of a sensor without a probe tip.

FIG. 9: Schematic illustration of a non-limiting example process for the construction of a composite sensor by the low-temperature solution (LTS) method.

FIGS. 10A-10D: TEM images of CeNPs synthesized at different temperatures: 30° C. (FIG. 10A), 120° C. (FIG. 10B), and 150° C. (FIG. 10C). For comparison, PRIOR ART FIG. 10D shows a TEM image of commercial CeNPs used on a known free radical sensor with Prussian blue.

FIG. 11: XRD experimental results for CeNPs of 8 nm (diffractogram a), 12 nm (diffractogram b), and 16 nm (diffractogram c). For 50 wt % CeNPs/GO-LTS composites, 8 nm CeNPs/GO-LTS (diffractogram d), 12 nm CeNPs/GO-LTS (diffractogram e), and 16 nm CeNPs/GO-LTS (diffractogram f) are shown. GO stands for graphene oxide.

FIGS. 12A-12J: STEM images and EDS maps of 8 nm CeNPs/GO-LTS composites with different CeNPs loadings on the composites of 10 wt % (FIGS. 12A-12B), 25 wt % (FIGS. 12C-12D), 50 wt % (FIGS. 12E-12F), 75 wt % (FIGS. 12G-12H), and 90 wt % (FIGS. 12I-12J). GO stands for graphene oxide and LTS stands for low-temperature solution method.

FIGS. 13A-13D: CV results of the CeNPs/GO-LTS composites for different sizes of CeNPs on the composite and different CeNPs loadings: 8 nm (FIG. 13A), 12 nm (FIG. 13B), and 16 nm (FIG. 13C) in 5 mM solution of [Fe(CN)₆]^{3-/4-} in a mixture of 0.1 M KCl and phosphate-buffered saline (PBS) buffer solution at pH 7.2. FIG. 13D shows a comparison of CV results from 8, 12, and 16 nm at 50 wt % CeNPs loading. No ●OH radicals were generated for these experiments. GO stands for graphene oxide and LTS stands for low-temperature solution method.

FIG. 14: Bar graphs showing the relationship between the redox response and the size and loading of the CeNPs on the CeNPs/GO-LTS composites, where GO stands for graphene oxide and LTS stands for low-temperature solution method.

FIG. 15: Line plots showing the relationship between the current response and the size of the CeNPs on the 50 wt % CeNPs/GO-LTS composites for different hydroxyl radical concentrations, where GO stands for graphene oxide and LTS stands for low-temperature solution method.

FIGS. 16A-16C: FTIR spectra of conductive carbon (FIG. 16A), acid-treated conductive carbon (FIG. 16B), and 2.5 wt % CeNPs/C-SOG composite (FIG. 16C), where C represents conductive carbon and SOG for surface organometallic grafting.

FIG. 17: TGA analysis of acid-treated conductive carbon and 12.3, 18.4, 24.6 wt % CeNPs/C-SOG composites prior to thermal treatment in inert, where C represents conductive carbon and SOF stands for surface organometallic grafting.

FIGS. 18A-18D: STEM images of 2.5 wt % CeNPs/C-SOG (FIGS. 18A-18B) and 18.4 wt % CeNPs/C-SOG (FIGS. 18C-18D), where C represents conductive carbon and SOG represents surface organometallic grafting.

FIGS. 19A-19B: Bar graphs showing the relationship between the CeNPs loading on CeNPs/C-SOG composites and the sensor response to hydroxyl radicals, where C stands for conductive carbon and SOG stands for surface organometallic grafting.

FIGS. 20A-20D: Bar graphs comparing CeNPs/C-SOG and CeNPs/GO-SOG synthesized by surface organometallic grafting (SOG) on different supports, without (FIGS. 20A-20B) and with (FIGS. 20C-20D) normalization. C represents conductive carbon and GO represents graphene oxide.

FIG. 21A-21B: Bar graphs comparing CeNPs/C-SOG and CeNPs/GO-SOG synthesized by surface organometallic grafting (SOG), CeNPs/GO-LTS synthesized by the low-temperature solution (LTS) method, and Prussian blue-CeNPs/GO-LTS composite was conducted, without (FIG. 21A) and with (FIG. 21B) normalization. C represents conductive carbon and GO represent graphene oxide.

FIG. 22: Limit of detection (LOD) of each of the three types of sensors.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Provided herein are compositions, devices, and methods useful for detecting, sensing, scavenging, or removing free radicals such as, but not limited to, hydroxyl radicals. In general, the present disclosure involves sensing compositions comprising cerium oxide nanoparticles (CeNPs) on a carbon-based substrate. In some embodiments, the carbon-based substrate in a conductive, amorphous carbon, such as, but not limited to, carbon black. In some embodiments, the carbon-based substrate is graphene or graphene oxide. The sensing compositions may be provided in a reusable sensor with the ability to detect ROS accurately and consistently. The sensor may be a handheld device capable of real-time, accurate, and consistent sensing of ROS such as, but not limited to, hydroxyl radicals.

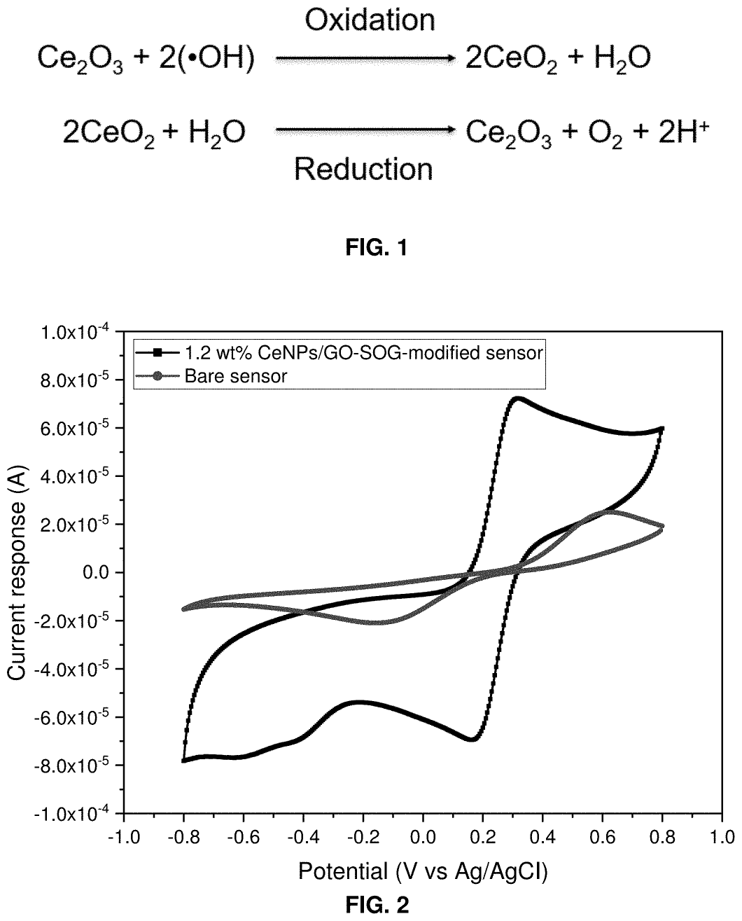

The strong affinity of cerium oxide toward hydroxyl radicals was used for the development of a highly sensitive sensor. The outstanding ability of CeNPs for scavenging ●OH radicals is due to their unique dual oxidation states, which can easily switch between Ce³⁺ and Ce⁴⁺ by reducing or oxidizing species in a medium. In the typical redox reaction with hydroxyl radicals, cerium (III) oxide is oxidized to cerium (IV) oxide with two moles of hydroxyl radicals (FIG. 1). The Ce³⁺ oxidation state of the CeNPs is believed to act as the active site for the redox reaction that scavenges ●OH radicals, as depicted in FIG. 1. The relationship between the cerium oxide morphologies and the number of Ce³⁺ has been investigated. It has been found that the particle size is an important factor that determine the amount of Ce³⁺ on the particle surface. For example, Deshpande et al. verified that the amount of Ce³⁺ increased from 0.17 to 0.44, in terms of the ratio of Ce³⁺ to the total of Ce³⁺ and Ce⁴⁺, by reducing the cerium oxide particle size from 30 nm to 3 nm. Thus, in some embodiments herein, the ratio of cerium (III) to cerium (IV) is at least 0.4, and the cerium oxide nanoparticles have an average size of about 2 nm. Zhang et al. also observed the particle size has a huge impact on the amount of Ce³⁺ on the surface. It has been found that the amount of Ce³⁺ is 0.016 for 15 nm CeNPs, while it is 0.094 for 6.1 nm CeNPs. Interestingly, there is no Ce³⁺ on the surface of the CeNPs when they are larger than 5,000 nm. Thus, the scavenging activity of CeNPs toward ●OH radicals is related to the particle size due to the amount of Ce³⁺ on the surface. The size and shape of CeNPs also have an effect on the ●OH radical scavenging capacity, which were reported by Filippi et al., such that the scavenging capacity is better with 25 nm CeNPs compared to 50 nm CeNPs, and this difference is explained by the larger surface area and higher defect density of smaller CeNPs. Consequently, the particle size and concentration of CeNPs are important factors in constructing a highly sensitive and selective electrochemical composite sensors for ●OH radical detection and scavenging.

In a first aspect, a sensing composition comprises a composite of cerium oxide nanoparticles and graphene oxide, also referred to herein as a CeNPs/GO composite or simply CeNPs/GO. The CeNPs/GO composite may include an average particle size of less than 20 nm, such as about 5 nm, and may be prepared through a low-temperature solution process (LTS). The CeNPs/GO composite may optionally be deposited or formed on a conductive material such as a metal or a glassy carbon electrode to form a sensor for detecting free radicals, or may be used as a sensor for detecting free radicals without an additional conductive material.

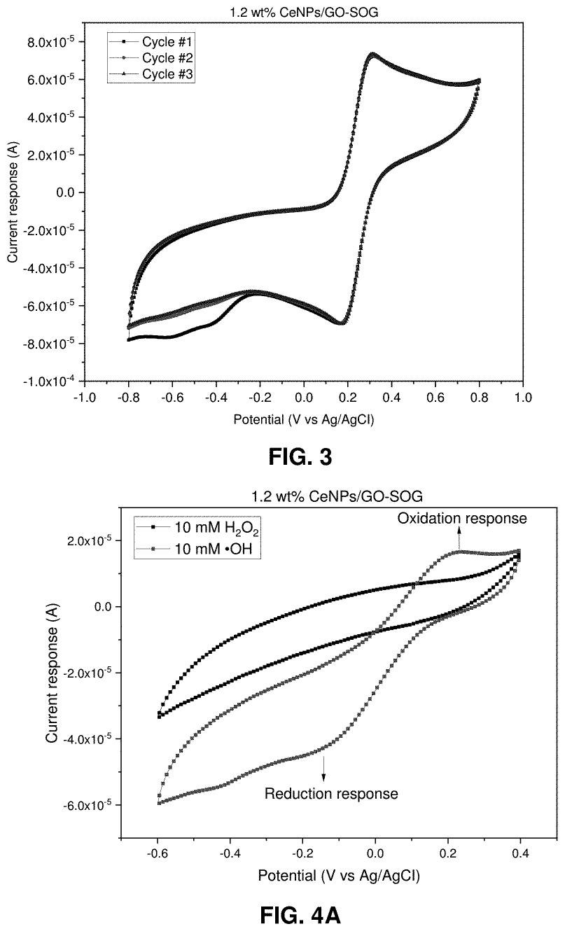

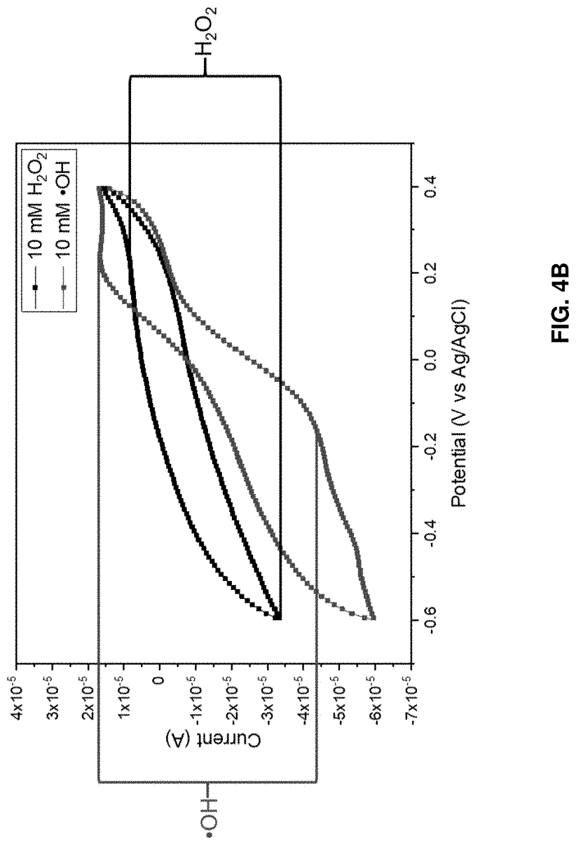

As described in the examples herein, in order to maximize the amount of Ce³⁺ sites, and thus, the performance and sensitivity of the sensor, a material with nanosized cerium oxide nanoparticles was synthesized. As noted above, the Ce³⁺/Ce⁴⁺ ratio is determined by the size of the cerium oxide nanoparticles. Therefore, a method to synthesize ultrasmall cerium oxide nanoparticles with a high concentration of Ce³⁺ (for example, about 43% Ce³⁺) was developed. These cerium oxide nanoparticles can be dispersed in graphene oxide through a surface organometallic grafting (SOG) method to increase the sensitivity of the resulting sensor (CeNPs/GO-SOG) as described in the examples herein. FIG. 2 confirms the presence of the 1.2 wt % CeNPs/GO-SOG composite (CeNPs on graphene oxide by surface organometallic grafting) on the sensor surface, and FIG. 3 proves the stability of the composite on the sensor. FIGS. 4A-4B show the selectivity of the sensor to hydroxyl radicals when compared with H₂O₂. As can be seen in FIGS. 4A-4B, the sensor shows an oxidation and a reduction peak in the presence of ●OH radicals.

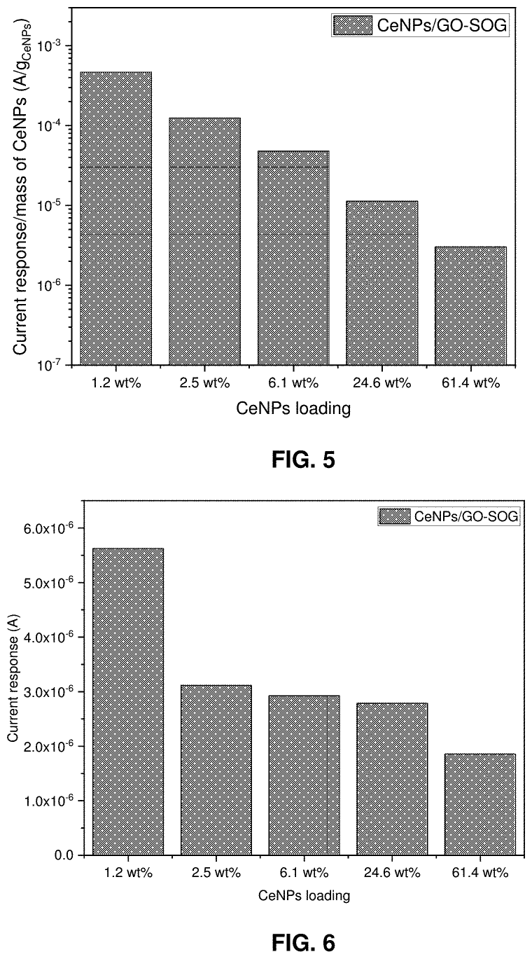

The amount of CeNPs present in the composite may range from about 0.2% to about 75%, or from about 0.5% to about 50%, or from about 1% to about 30% by weight. As seen in FIG. 5, the sensor response with the 1.2 wt % CeNPs/GO-SOG composite is exceptional when compared with higher loadings prepared by the same synthesis method (SOG). Higher loadings contribute to agglomeration of the cerium oxide nanoclusters to form bigger particles (thus, lower content of Ce³⁺ sites).

FIG. 6 compares the sensor response per mass of CeNPs for various CeNPs/GO-SOG composites prepared by surface organometallic grafting (SOG) (normalized plot). As seen in FIG. 6, the 1.2 wt % CeNPs/GO-SOG sample is also the most efficient one, as the same mass of CeNPs is able to provide the highest response.

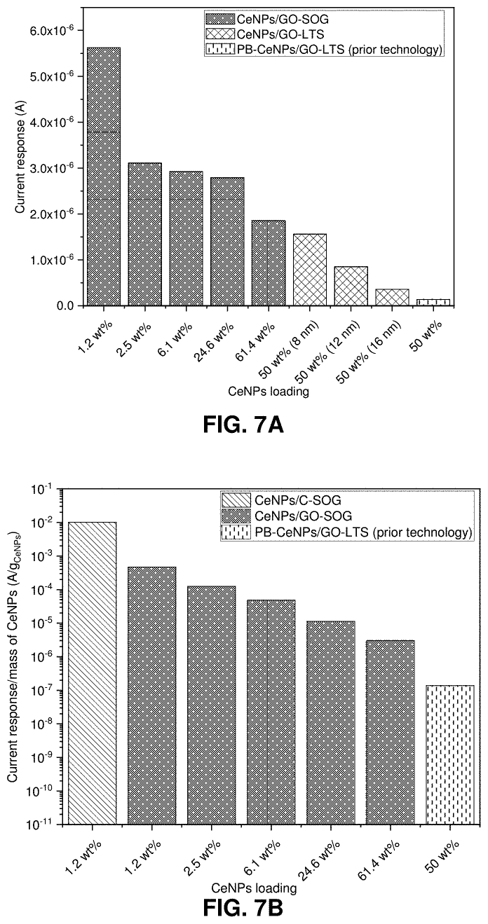

The CeNPs/GO-SOG composites have been compared with others synthesized using different methods (FIGS. 7A-7B). The CeNPs/GO-SOG composites were compared to the composites described in US Patent Application Publication No. 2019/0212286 A1 (incorporated herein by reference for all purposes), which involve 25 nm CeNPs plus Prussian blue (PB) and graphene oxide. Also, the synthesis of CeNPs nanoparticles was conducted with different sizes (8, 12, and 16 nm) and the CeNPs were physically mixed with graphene oxide by the low-temperature solution (LTS) process (50 wt % CeNPs on the composite). The CeNPs/GO-LTS composites formed from the low-temperature solution process (i.e., having small CeOₓ nanoparticles) provided better results than those with Prussian blue. As seen in FIG. 7B, the sensor response per mass of CeNPs from the 1.2 wt % CeNPs/GO-SOG composite was five orders of magnitude higher compared to a sensor with Prussian blue, making these composites super sensitive sensors. The sensors and sensing compositions described herein may be completely free of Prussian blue.

In a second aspect, the sensor may include a sensing composition comprising ultra-small cerium oxide nanoparticles deposited on a conductive, amorphous carbon substrate. The conductive, amorphous carbon substrate may include or consist of an amorphous carbon. In general, amorphous carbon is reactive carbon that does not have any crystalline structure, though may have some short-range order. Amorphous carbon is distinct from graphite and diamond, and may include impure forms of carbon such as coal, soot, carbide-derived carbon, carbon black, or combinations thereof. Advantageously, amorphous carbon is generally cheaper than graphene and graphene oxide, and therefore, sensing compositions that include amorphous carbon provide a cost savings. The cerium oxide nanoparticles in the composition may have an average size of less than about 5 nm, such as about 1 nm, or about 2 nm, or about 3 nm, or about 4 nm.

As described in the examples herein, ultra-small cerium oxide nanoparticles (CeNPs) can be deposited on a conductive, amorphous carbon substrate through a surface organometallic grafting (SOG) process. The process may involve first surface modifying the amorphous carbon substrate with an acid treatment step so as to functionalize the surface with carboxyl groups, then grafting a cerium precursor such as tris(cyclopentadienyl)cerium(III) onto the amorphous carbon by adding a precursor solution to the amorphous carbon and stirring under inert atmosphere until disappearance of color, and then removing solvent and drying, followed by thermally treating the product to remove ligands. This product can be deposited onto a conductive electrode such as a glassy carbon electrode or a metal electrode and subsequently used as a sensor for free radicals such as hydroxyl radicals. Alternatively, the product can be used as a sensor without an additional conductive electrode.

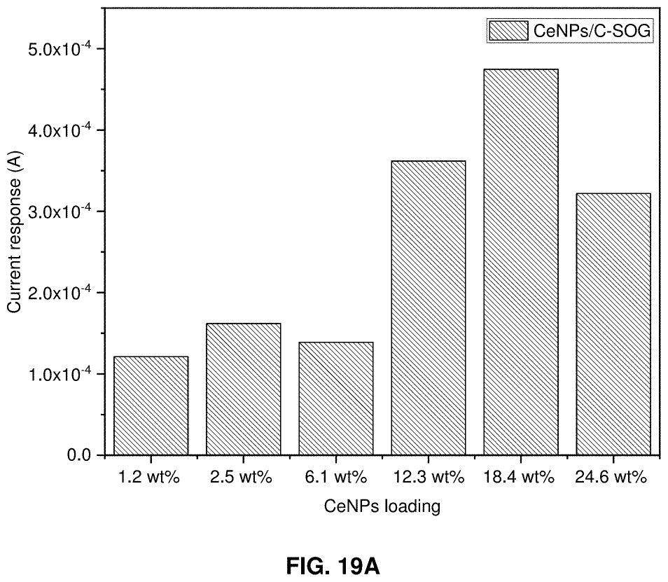

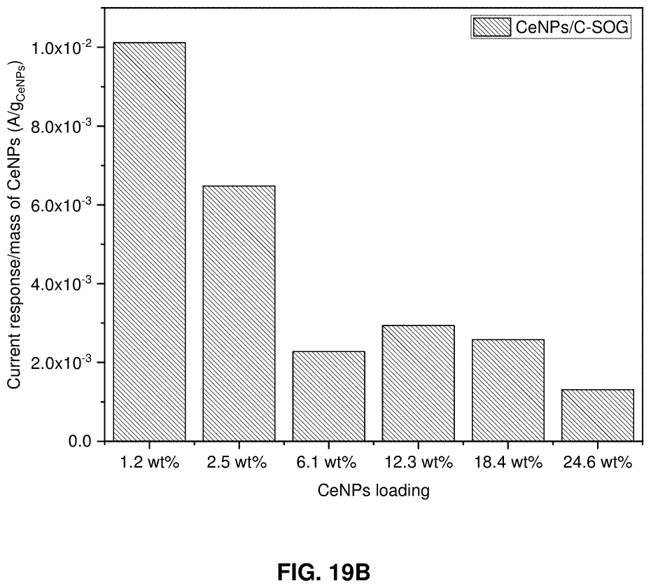

The CeNPs may be present in the composition in an amount ranging from about 0.2 wt % to about 75%, from about 1 wt % to about 50 wt %, or from about 2 wt % to about 20 wt %. As seen in FIG. 19A, a 18.4 wt % CeNPs loading results in the best overall current response of the CeNPs/C-SOG sensors, but as seen in FIG. 19B, a 1.2 wt % CeNPs loading results in superior current response per gram of CeNPs. Furthermore, the CeNPs may have a ratio of Ce³⁺ to Ce⁴⁺ of from about 30:70 to about 50:50. In some examples, the Ce³⁺/Ce⁴⁺ ratio is about 40:60.

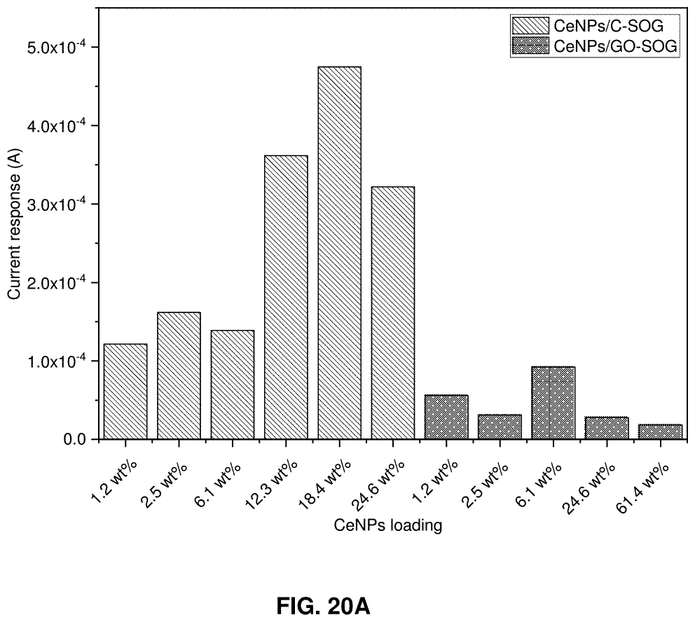

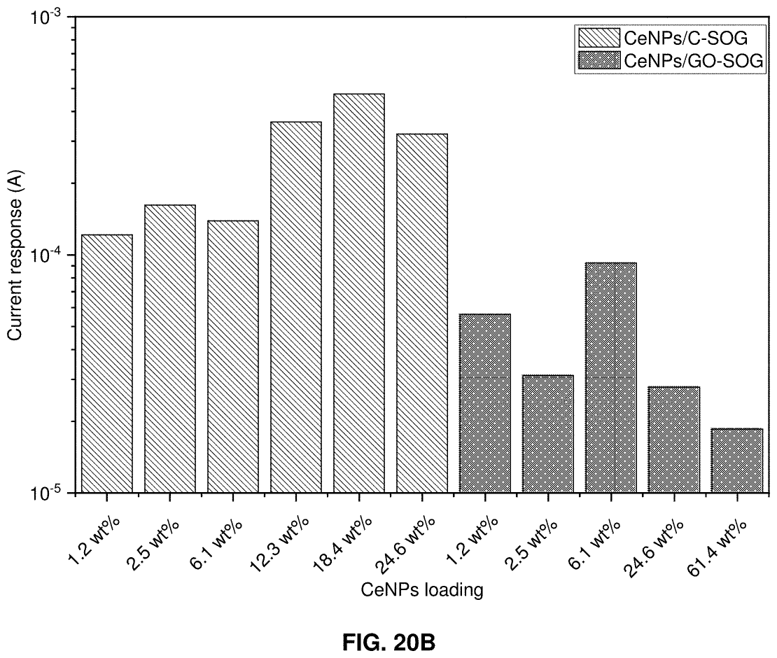

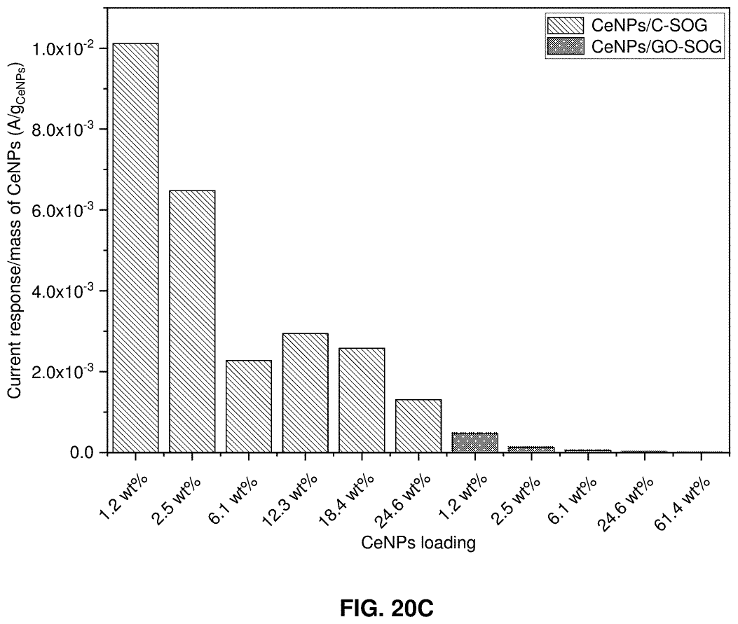

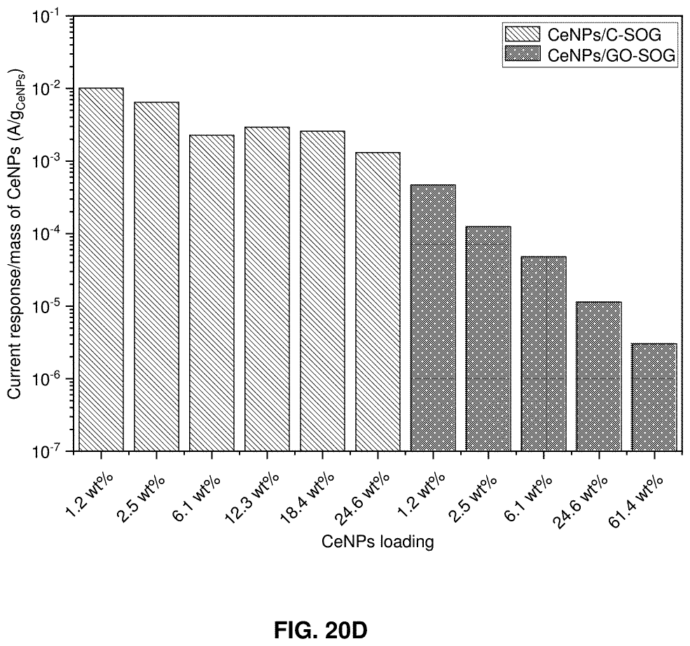

As shown in the examples herein, sensors comprising CeNPs on a conductive, amorphous carbon substrate show significantly improved response to hydroxyl radicals, even compared to sensors comprising the CeNPs/GO composites described above. (FIGS. 20A-20C.)

Thus, the present disclosure provides multiple embodiments of sensing compositions: CeNPs deposited onto carbon (C) or graphene oxide (GO) by low-temperature solution (LTS), and CeNPs/C by surface organometallic grafting (SOG). The acronyms LTS and SOG are used herein to distinguish the methods of preparation. Weight percentages are given as wt % CeNPs/C or GO, for either LTS or SOG.

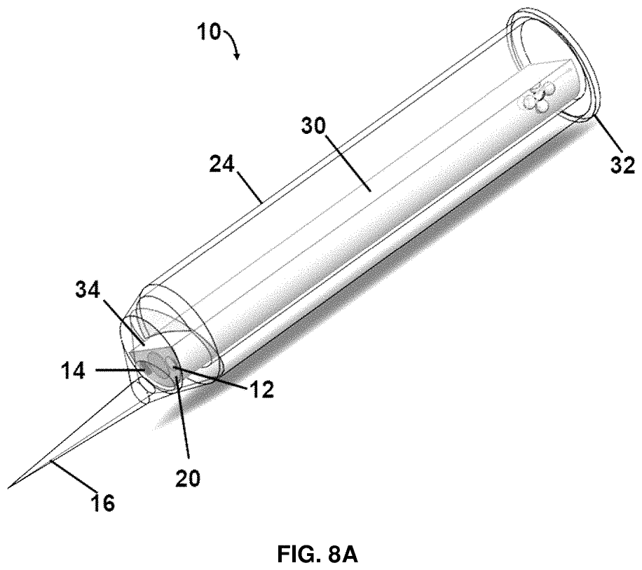

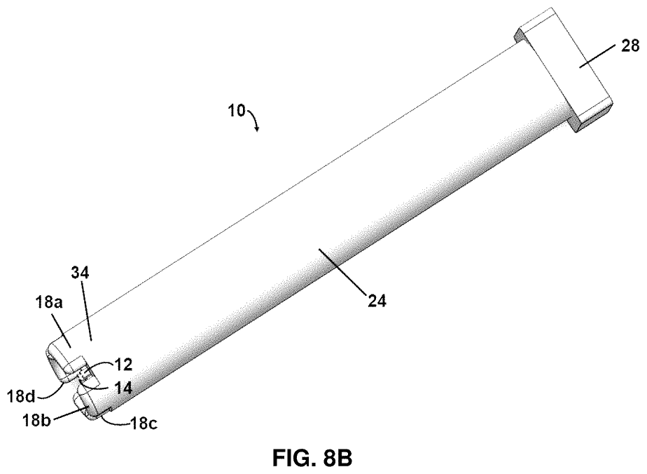

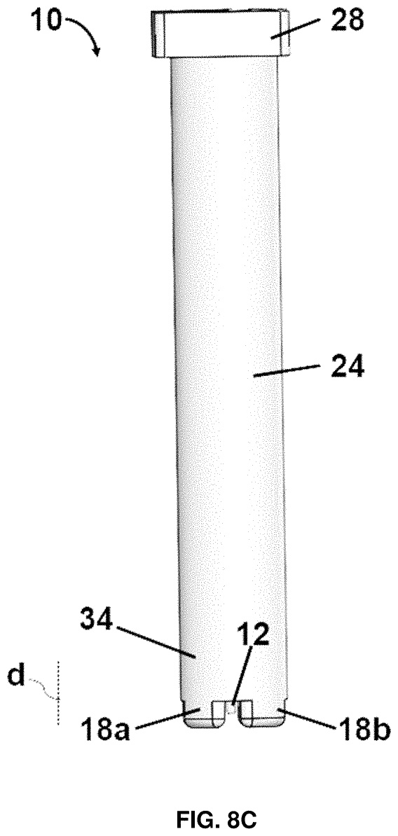

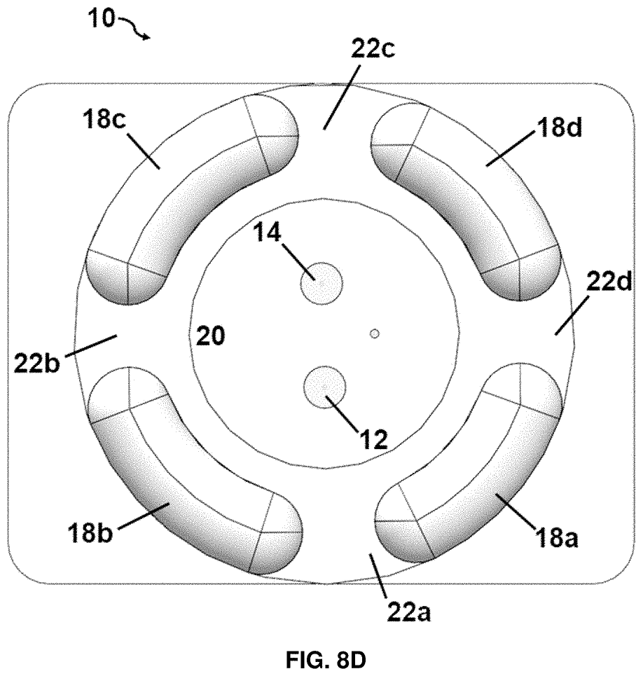

Referring now to FIGS. 8A-8D, a non-limiting example sensor 10 is depicted. The sensor 10 includes a sensing composition on a working electrode 12, where the sensing composition comprises cerium oxide nanoparticles deposited on a carbon-based substrate. The sensor 10 may further include a counter electrode 14. The working electrode 12 and the counter electrode 14 are best seen in FIG. 8D. The sensor 10 directly interacts with the area where the source of free radical generation is. The sensor 10 may be utilized for real-time free radical detection.

In some embodiments, the sensor 10 may include an elongated body 30 housed within a sheath 24 having a probe tip 16 designed to contact the area to be measured without the electrodes 12, 14 experiencing disturbances from surrounding non-specific solid materials. The probe tip 16 can work in contact with the area or it can be easily inserted into the area to be measured. The probe tip 16 is an elongated hollow member providing access to the sensing area 20 at the distal end 34 of the elongated body 30, where the working electrode 12 and counter electrode 14 are disposed. The sensor 10 may further include a removable cap 28 at a proximal end 32 of the sensor 10. The removable cap 28 may be removed to allow access into the sheath 24.

In some embodiment, the sensor 10 may include a sheath 24 that does not include the probe tip 16. The sensor 10 may include curved ridges 18a, 18b, 18c, 18d that extend a distance d beyond the elongated body 30, the sheath 24, and the sensing area 20 to keep a distance d between the surface of the object to be sensed (for example, human tissue) and the sensing area 20. In this manner, the sensing composition only contacts fluid on the surface of the object. In one non-limiting example, the distance d is about 10 microns. However, other distances are possible and entirely encompassed within the scope of the present disclosure. The orientation of the curved ridges 18a, 18b, 18c, 18d may leave four openings 22a, 22b, 22c, 22d through which fluid may flow when the curved ridges 18a, 18b, 18c, 18d are in contact with the surface to be sensed. The sensing area 20 may be defined as a circular area bounded by the curved ridges 18a, 18b, 18c, 18d and the openings 22a, 22b, 22c, 22d. However, other orientations and numbers of curved ridges 18 and openings 22 are entirely possible and encompassed within the scope of the present disclosure.

The sensor 10 may be used, for example, to aid in cancer removal surgeries, where a surgeon must determine how much tissue to remove around a tumor. The surgeon may use the sensor 10 to determine a radius of tissue around the tumor where the ROS concentration is high enough to warrant removal of the tissue so as to ensure removal of all the cancerous cells.

The sensor 10 may operate by taking impedance measurements, which may take about 10 seconds. Alternatively, the sensor 10 may operate through cyclic voltammetry as seen, for example, in FIGS. 2-4, 9, 13. However, impedance measurements may be quicker than cyclic voltammetry. In some embodiments, the sensor 10 includes a plurality of sensing areas 20, so as to speed up the time it takes to obtain a measurement.

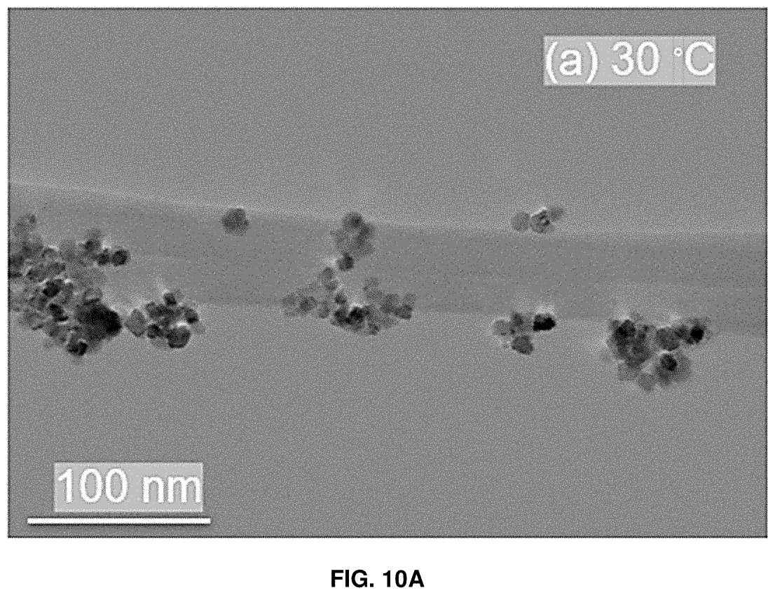

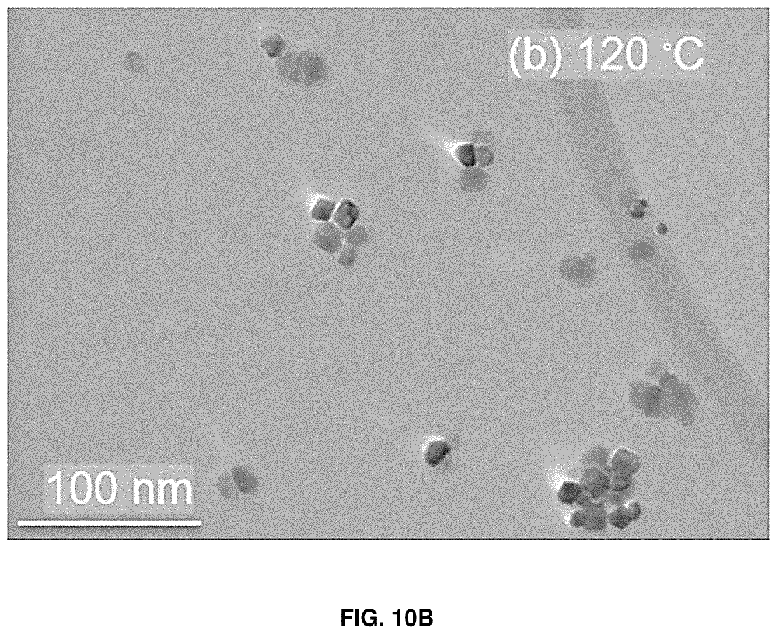

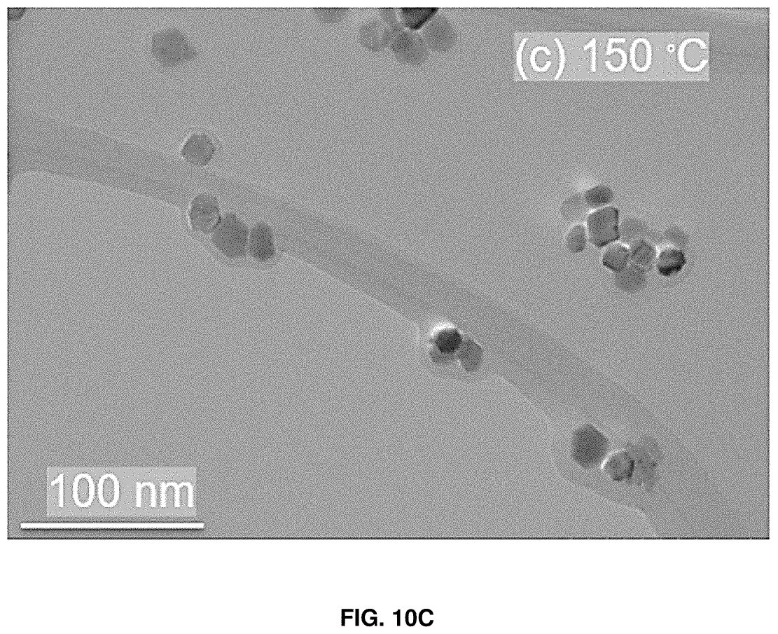

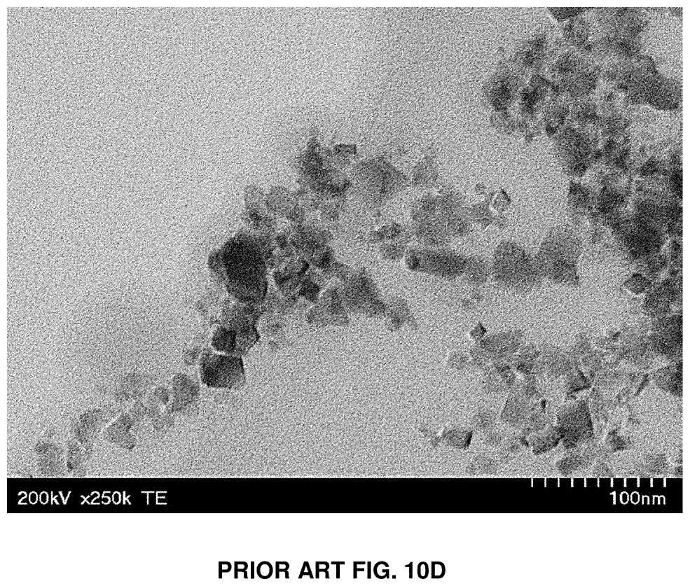

As seen in FIGS. 10A-10D, the sensing compositions described herein have advantages over known compositions. Whereas a known composition, seen in PRIOR ART FIG. 10D, has non-uniform commercial CeNPs of a size ranging from 30-50 nm, one example sensing composition formed from the low-temperature solution process described herein has uniform CeNPs of size of about 8 nm (FIG. 10A).

Any of the sensing compositions described herein can also be utilized in a free radical scavenger instead of a free radical sensor. For example, a sensing composition as described herein may be embedded into a membrane, such as a PEM membrane. This may be done through the same methods in which cerium oxide is currently added to such membranes, for example by injecting particles in the molding. Advantageously, this will not compromise the membrane performance. Non-limiting examples of porous membranes include membranes made of polytetrafluoroethylene, polytetrafluoroethylene-chlorotrifluoro, ethylene copolymer, polychlorotrifluoroethylene, polybromotrifluoroethylene, polytetrafluoroethylene-bromotrifluoroethylene copolymer, polytetrafluoroethylene-perfluorovinyl ether copolymer, polytetrafluoroethylene-hexafluoropropylene, or copolymers thereof. Such a membrane with the sensing compositions described herein embedded into it may be utilized, for example, in a fuel cell. Hydroxyl radicals obtained by radicalizing hydrogen peroxide are known to deteriorate the membrane in a fuel cell. Accordingly, the compositions described herein may provide improved fuel cells by scavenging free radicals in a filter or membrane placed within the fuel cell.

### EXAMPLES

### Example I—the Effect of Size and Content of Cerium Oxide Nanoparticles on a Composite Sensor for Hydroxyl Radicals Detection

A glassy carbon electrode (GCE) was modified with a composite of cerium oxide nanoparticles and graphene oxide (CeNPs/GO) to be employed as a sensing device for hydroxyl (●OH) radicals. Cerium oxide nanoparticles (CeNPs) were synthesized using a co-precipitation method, and the CeNPs/GO composites were produced using a low-temperature solution process (LTS) (CeNPs/GO-LTS composites). Scanning transmission electron microscopy (STEM) and energy dispersive spectroscopy (EDS) were used to determine the average size and the distribution of CeNPs in the composite. X-ray powder diffraction (XRD) confirmed the composition of the CeNPs/GO composites. Cyclic voltammetry (CV) was used to characterize the interaction of the composite sensor with ●OH radicals in the Fenton reaction. The effects of CeNPs particle size and loading on the current response with ●OH radicals were examined using 8, 12, and 16 nm CeNPs at loadings of 10, 25, 50, 75, and 90 wt % of CeNPs in the composite. The CeNPs/GO-LTS composite with 8 nm CeNPs showed the largest current response with ●OH radicals for all tested CeNPs loadings. A composite containing 50 wt % of CeNPs showed the largest current response in ●OH detection. The lowest detection limit (0.085 mM) was observed with the composite comprising 8 nm CeNPs with a 50 wt % loading (50 wt % CeNPs (8 nm)/GO-LTS). When the CeNPs loading in the composite is above 50 wt %, the agglomeration of CeNPs together with a reduced conductivity due to the lesser amount of GO result in lower current changes of the redox reaction. The results demonstrated that the small size of CeNPs (8 nm) with 50 wt % loading produced the largest current change from the redox reaction with ●OH radicals.

In the present example, a carbon electrode was modified with a composite of CeNPs and graphene oxide (GO). The size of CeNPs and the ratio between CeNPs and GO were varied to investigate their relationship with sensing performance of the composites towards ●OH radicals. As noted above, the scavenging activity of CeNPs is greatly related to their particle size. To overcome the poor conductivity of CeNPs, graphene oxide (GO) was chosen as the second component of the sensor composite. GO was selected due to its intrinsic high conductivity and surface area. The effect of the size of CeNPs on the reactivity with ●OH radicals was examined using 8, 12, and 16 nm CeNPs. For the effect of the CeNPs loading, 10, 25, 50, 75, and 90 wt % of CeNPs were used.

Materials, Reagents, and Apparatuses

Cerium(III) nitrate hexahydrate (>99%), graphene oxide, potassium hexacyanoferrate(II) trihydrate (98.5-102.0%), potassium hexacyanoferrate(III) (>99%), iron(III) chloride (97%), iron(II) sulfate heptahydrate (99%), potassium chloride (≥99%), and 30 wt % hydrogen peroxide solution were obtained from Sigma-Aldrich. Screen-printed carbon electrodes (Pine Instruments) were used as the sensor base with 2 mm working electrodes. The sizes of CeNPs and CeNPs/GO composites were recorded and confirmed by scanning transmission electron microscope, STEM, (Hitachi HD-2300A, Japan). The composition of the CeNPs/GO-LTS composites was confirmed by Rigaku Ultima III X-ray Diffractometer with Small Angle X-ray Scattering (SAXS). The XRD patterns were obtained using the 2θ range from 20° to 90° operating with a Cu target and Cu-K α radiation of 0.15406 nm wavelength at a power rating of 40 kV and 44 mA. The crystallite size was determined by Scherrer's equation. Cyclic voltammetry (CV) was performed using a Gamry Reference 600 potentiostatic (Gamry Instruments, USA).

Synthesis of Cerium Oxide NPs

Cerium oxide nanoparticles (CeNPs) were synthesized by precipitation. Briefly, 50 mL of a cerium nitrate solution was mixed with 25 mL of a 3 M NH₄OH solution. The operating temperatures were varied depending on the desired size of CeNPs: 30, 80, and 120° C. for 8, 12, and 16 nm particle sizes, respectively. After 2 h, the resulting product was recovered and rinsed with deionized water three times. Then, the CeNPs were dried in an oven at 60° C. for 12 h. CeNPs were then stored at room temperature in a desiccator. XRD and STEM were used to determine the average CeNPs particle size.

Synthesis of CeNPs/GO-LTS Composites

For the synthesis of the CeNPs/GO-LTS composites, 100 mg of CeNPs and GO with different weight ratios were mixed in 100 mL of deionized water. For example, 10 mg of CeNPs and 90 mg of GO were used for the preparation of the 10 wt % CeNPs/GO-LTS composite. The solution of dispersed CeNPs and GO in DI water was then placed in an ultrasonic bath for 1 h for homogenization. Following sonication, the mixed solution was stirred for 2 h to obtain the CeNPs/GO-LTS composite. The solid sample was collected by centrifugation and dried at 60° C. for 12 h. Once dry, the solid was grounded to a fine powder and kept in a desiccator at room temperature. XRD and STEM/EDS were used to confirm the presence of CeNPs and GO in the composite matrix.

Deposition of the CeNPs/GO-LTS Composite on a Glassy Carbon Electrode

For every composite, 10 mg of CeNPs/GO-LTS was suspended in 10 mL of deionized water. The solution was then sonicated for 1 h and deposited onto the working electrode by delivering a single drop (8 μL) using a micropipette. The droplet was dried in an over at 60° C. for 1 h. Once dried, the sensor was rinsed with deionized water and dried by gently flowing nitrogen gas. Cyclic voltammetry (CV) was used to confirm the presence of the composite on the electrode surface. The potential range selected for cyclic voltammetry was from −0.8 V to 0.8 V with scan rate of 100 mV/s using a 5 mM solution of [Fe(CN)₆]^{3-/4-} in a mixture of 0.1 M KCl and phosphate-buffered saline (PBS) buffer solution at pH 7.2.

Detection of ●OH Radicals by the CeNPs/GO-LTS—Modified Electrode

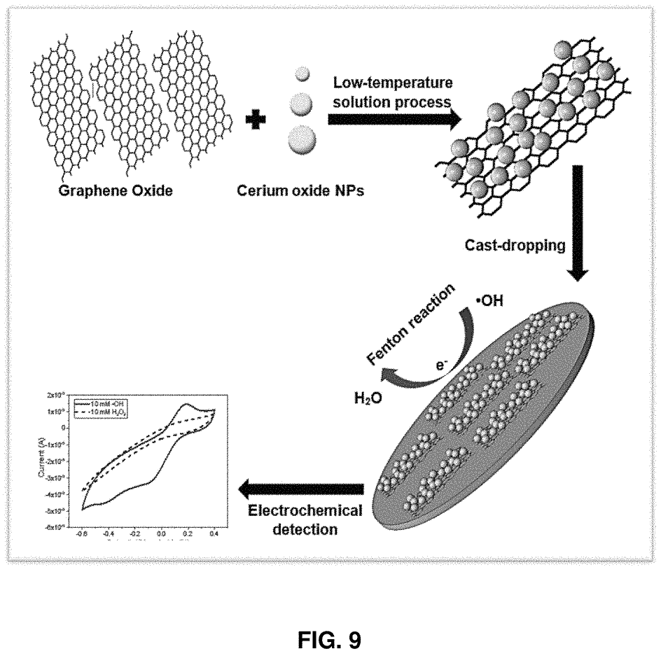

The Fenton reaction was used to generate ●OH radicals for the CV experiments, where there were equal volumes of 10 mM solution of H₂O₂ and FeSO₄.7H₂O. In this Fenton reaction, ●OH radicals were produced via the reduction of H₂O₂ in the presence of Fe²⁺ ions. After that, the composite-modified electrode was put into the Fenton reaction to detect ●OH radicals by using CV. The first cycle of CV was carried out using the H₂O₂ solution. After that, the electrode was removed from the solution, and then an equal volume of the iron (II) sulfate solution was added to generate ●OH radicals. Then, the electrode was immersed in the mixing solution of H₂O₂ and iron (II) sulfate to detect the presence of ●OH radicals. The potential range for CV was from 0.4 V to −0.6 V with 100 mV/s of scan rate. Both the reduction and oxidation responses, i.e., redox response, in the cyclic voltammogram were included to calculate the current change (ΔA) of the sensor due to the redox reaction between the composite and ●OH radicals. Therefore, the redox current change (ΔA) was calculated using the procedure described in FIG. 4B, where AA is taken from the difference between the current responses from H₂O₂ and ●OH radicals. The CV curve for H₂O₂ shows no significant redox peaks, which proves that there is no considerable redox reaction between the CeNPs/GO-LTS composite and H₂O₂. FIG. 9 summarizes the synthesis of the composite and the detection of ●OH radicals in solution.

Results

Synthesis of Cerium Oxide Nanoparticles and the Preparation of CeNPs/GO-LTS Composites

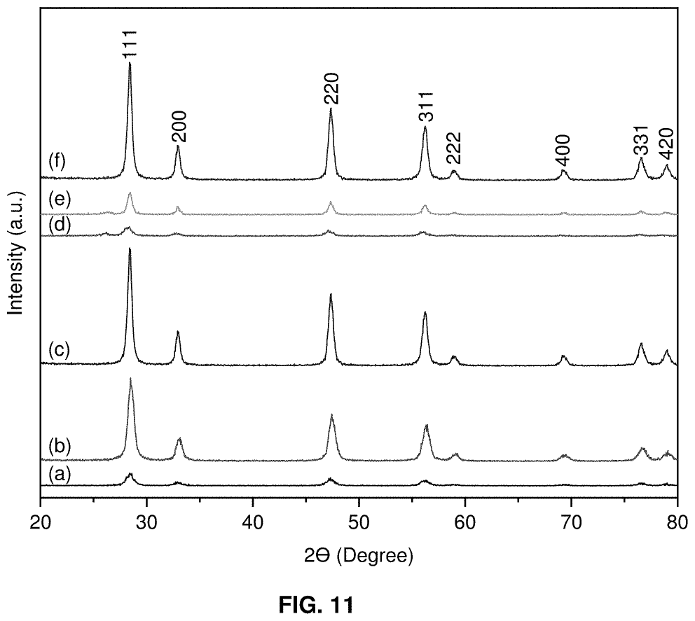

The CeNPs were synthesized at different temperatures to obtain different sizes of CeNPs. STEM was used to characterize the particle size, shape, and aggregation of CeNPs. FIGS. 10A-10C show STEM images obtained with the CeNPs synthesized at different temperatures: 30, 120, and 150° C. CeNPs show their typical cubic and hexagonal structures. XRD experiments were performed to determine the average particle sizes of CeNPs. As shown in FIG. 11, diffractograms a-c, which correspond to the CeNPs with different particle sizes, exhibit identical diffraction peaks at 28.4° (111), 32.9° (200), 47.3° (220), and 56.1° (311), 58.8° (222), 69.3° (400), 76.5° (331), 78.9° (420), which correspond to the standard cubic structure of cerium oxide (JCPDS 65-2975). The average particle size was determined using the Scherrer equation based on the eight diffraction peaks. From the calculation, the average diameters of CeNPs were 8, 12, and 16 nm with the synthesis temperature at 30, 120, and 150° C., respectively. Thus, this confirms that the CeNPs particle size can be controlled by specific reaction temperatures in the hydrothermal method. XRD experiments confirm the presence of CeNPs on the composite. As shown in the diffractograms d-f in FIG. 11, the same eight diffraction peaks appear on the CeNPs/GO-LTS composites, indicating that the composite was successfully synthesized by the low-temperature solution process at room temperature. Another important piece of evidence that validates the success of the synthesis protocol is the disappearance of the light yellowish color of the CeNP solution after contacting with the GO dispersion.

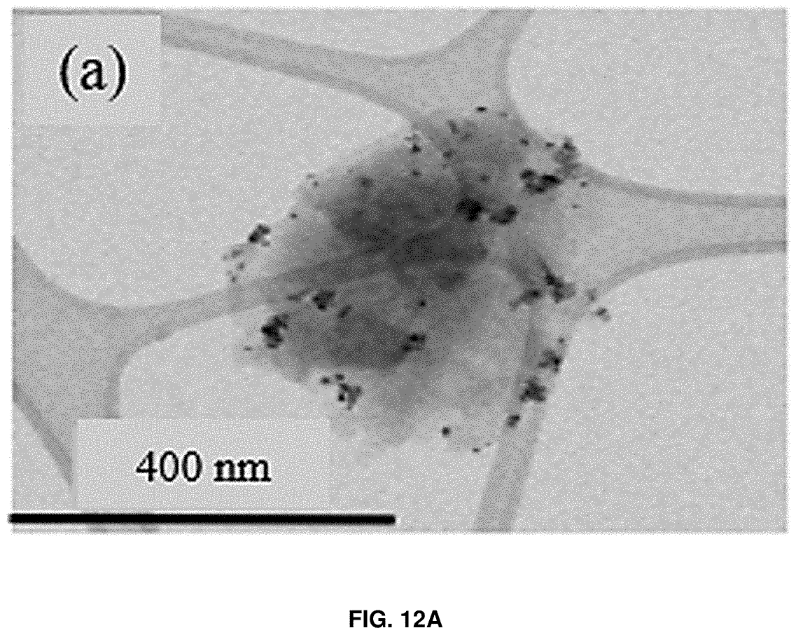

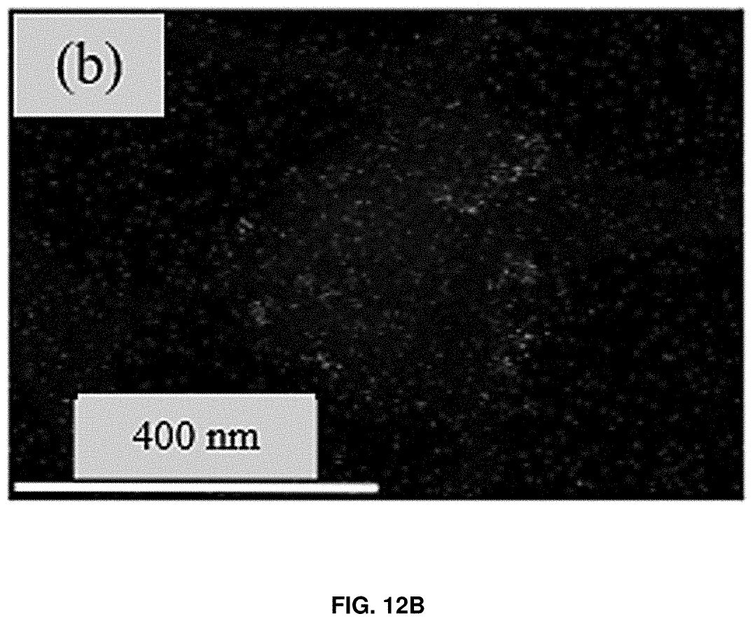

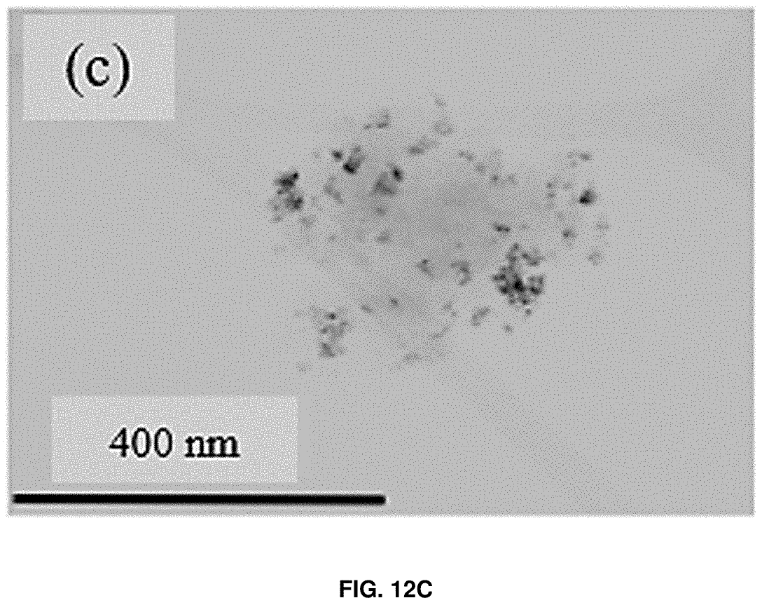

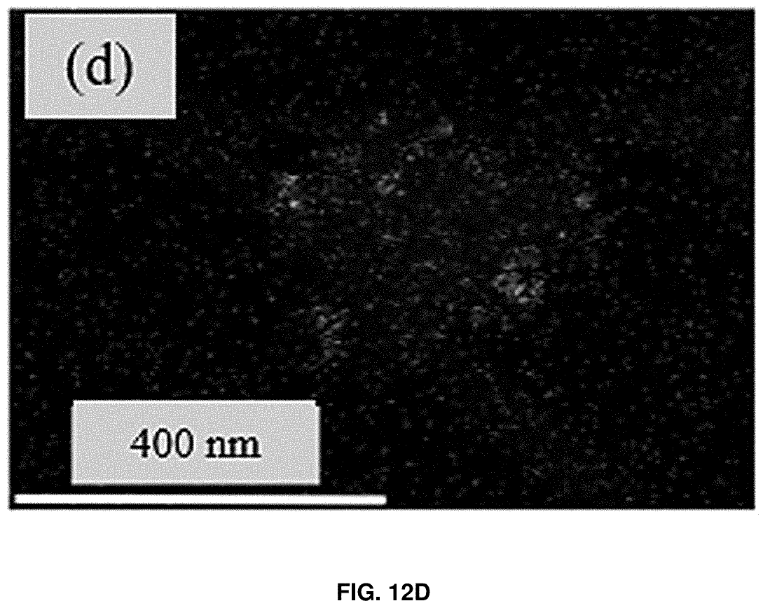

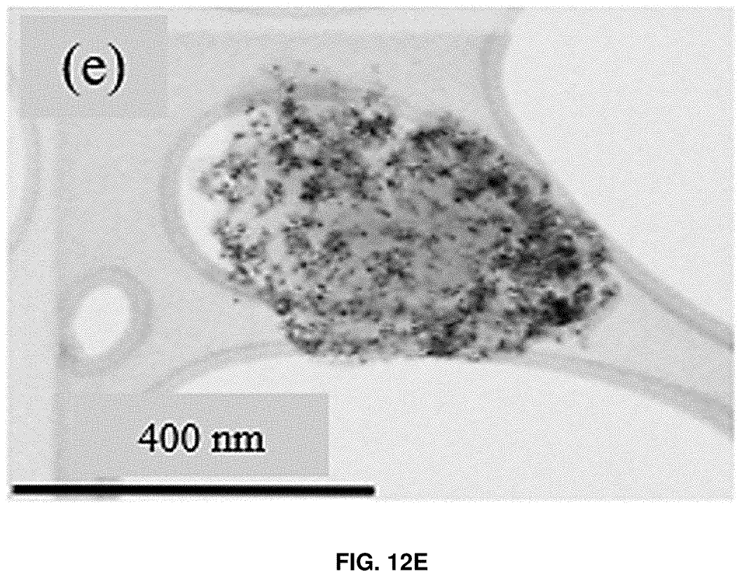

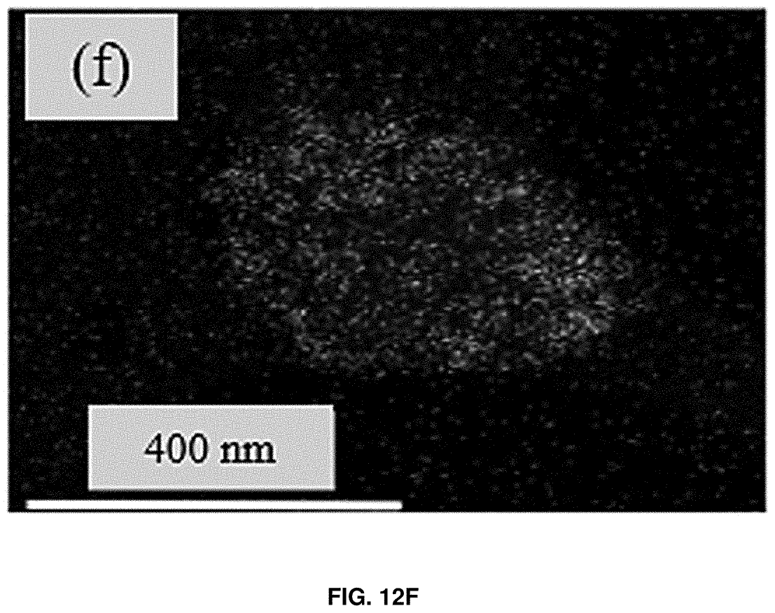

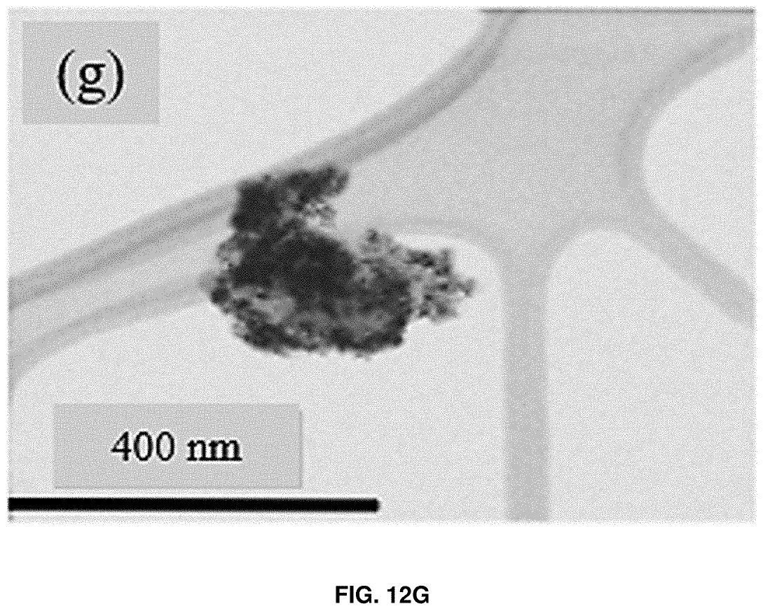

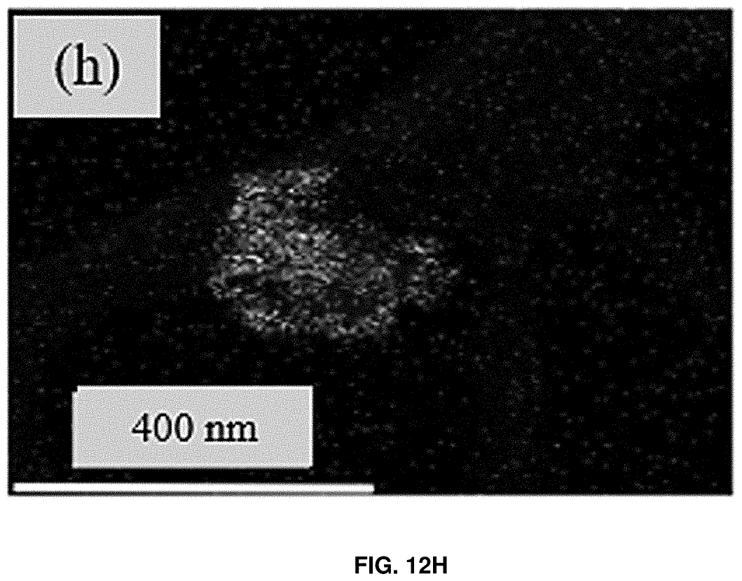

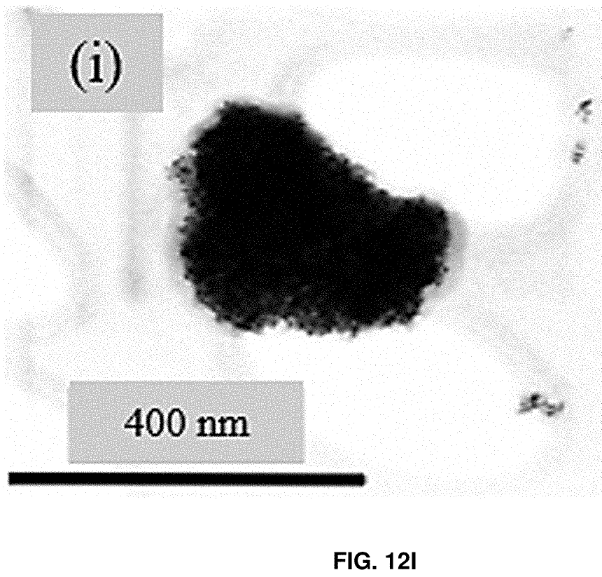

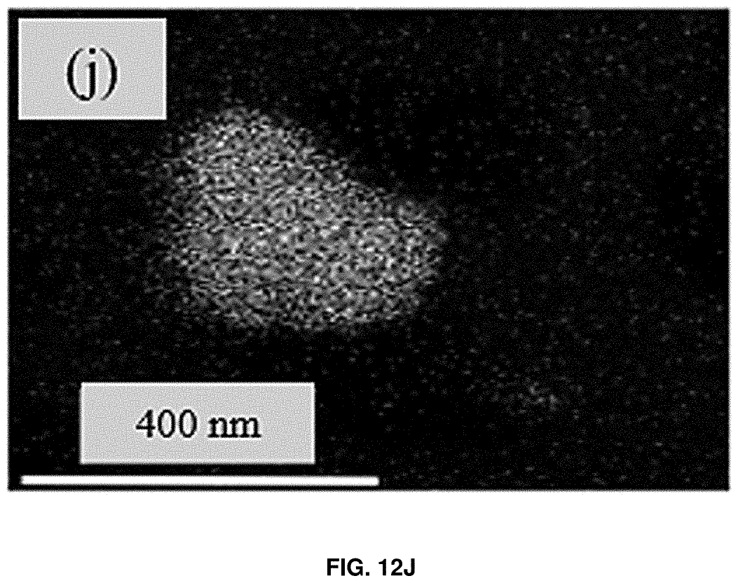

A suitable amount of CeNPs is required in the composite for its use as a sensing element of the sensor. STEM images were used to investigate the effects of CeNPs loading contents on the GO surface. FIGS. 12A-12J show the different STEM images obtained with the CeNPs (8 nm)/GO-LTS composite at different CeNPs loadings, 10, 25, 50, 75, and 90 wt % CeNPs in the composite. The amount of CeNPs in the composite increases according to the increase of CeNPs added at the beginning of the synthesis of the CeNPs/GO-LTS composite. The EDS results in FIGS. 12B, 12D, 12F, 12H, and 12J verify that the composite comprises CeNPs and GO, as both Ce (white) and C (blue) elements are present throughout the composites. As the content of CeNPs increased, white color becomes more dominant. It is readily noticeable that the largest aggregation of CeNPs happened in those composites with high CeNPs/GO ratios, which reduced both the contact area and the number of Ce³⁺ of the CeNPs. For example, CeNPs are dispersed in the composite with 25 wt % CeNPs loading (FIG. 12C) with less aggregation compared to that with 75 wt % CeNPs loading (FIG. 12G). When using 75 wt % CeNPs loading, the composite shows a high level of CeNP aggregation, in which it is difficult to identify individual CeNPs. In contrast, the 50 wt % CeNPs (8 nm)/GO-LTS composite shows a homogenous dispersion of the CeNPs on the GO surface. An increased dispersion of CeNPs in the composite results in a higher concentration of Ce³⁺ sites available for ●OH radicals that leads to more redox reactions, which improves the efficiency of the composite to detect and scavenge ●OH radicals.

Effect of CeNPs Particle Size and Loading on the Sensor Conductivity

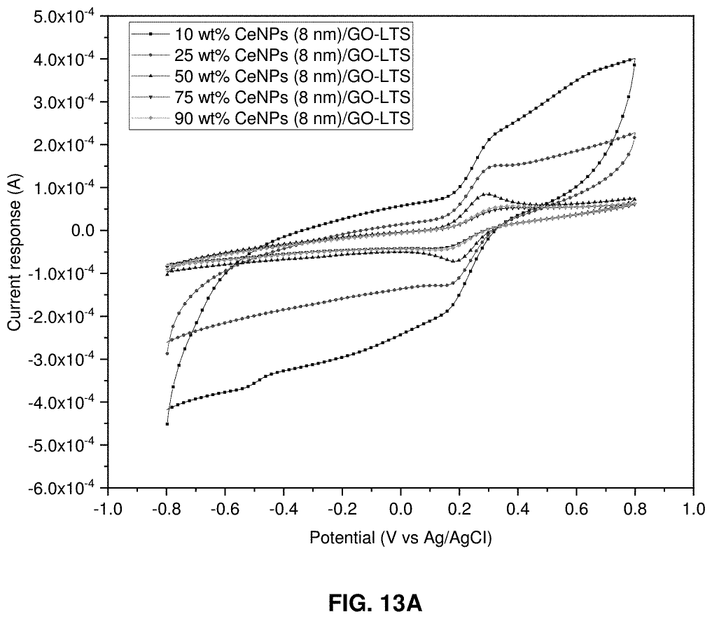

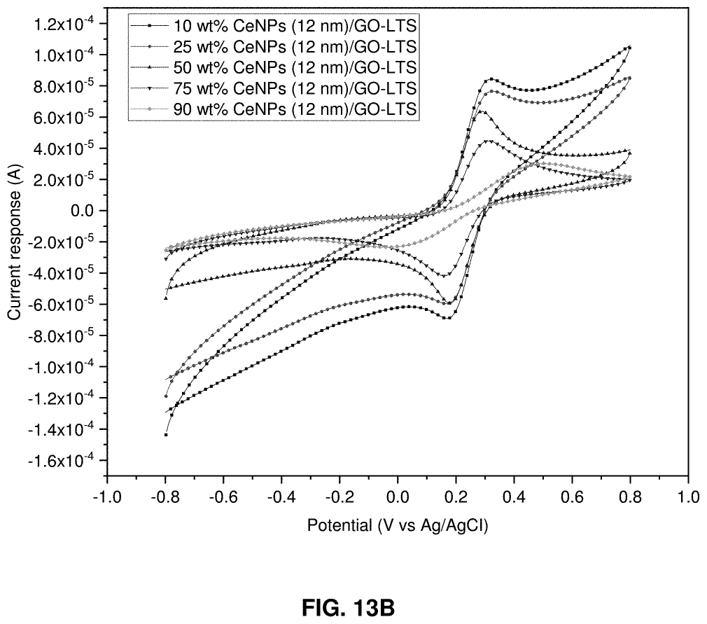

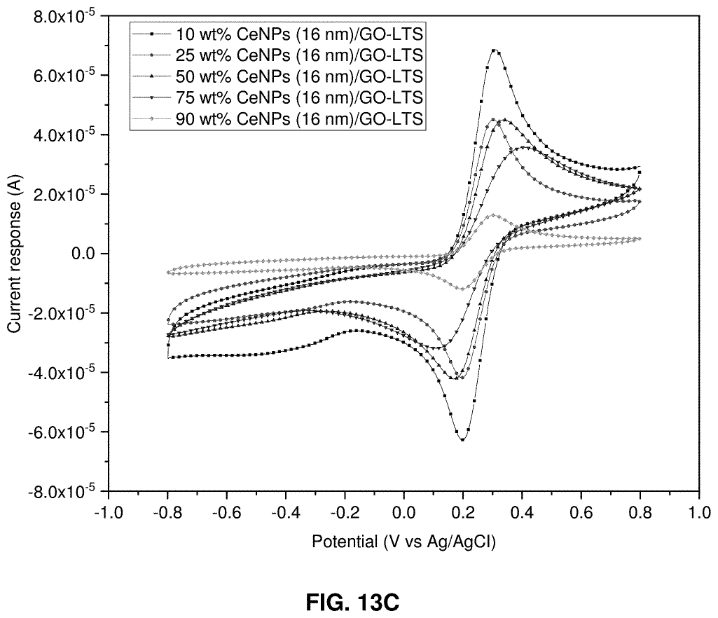

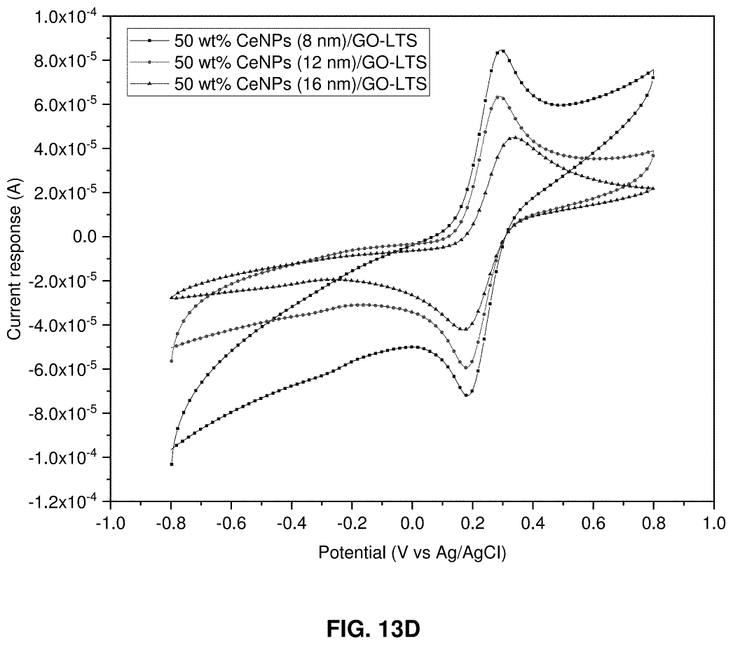

In order to determine the influence of the CeNPs particle size and its loading on the sensor conductivity for the detection of ●OH radicals, CV was conducted with various compositions of the composites. FIGS. 13A-13D show all cyclic voltammograms obtained with 8, 12, and 16 nm CeNPs using different CeNPs loadings, which were employed in 5 mM of [Fe(CN)₆]^{3-/4-} in 0.1 M KCl and a pH 7.2 phosphate-buffered saline (PBS) solution. As it can be seen in FIGS. 13A-13C, the current change (ΔA) increases when the CeNPs loading decreases, and the same trend is observed with 8, 12, and 16 nm CeNPs. This may be explained in terms of the increased amount of a highly conductive material as GO and the decrease of poorly conductive element as CeNPs in the composite. The above experimental results from FIGS. 13A-13C confirm the influence of the loading ratio on the sensor conductivity, which has a great impact on the sensor efficiency for ●OH radical detection. Surprisingly, the particle size of CeNPs also has an influence on the sensor conductivity (FIG. 13D). When comparing the different particle sizes using 50 wt % CeNPs/GO-LTS composites, the largest conductivity was obtained with the composite containing 8 nm CeNPs. The smaller sized nanoparticles are more dispersed on the surface of the GO and have a shorter distance for electrons to transfer between the electrode surface and the electrolyte solution in comparison to larger sized nanoparticles. With a shorter path for electron to transfer, the smaller sized composites have a higher conductivity as shown in the comparison of 8, 12 and 16 nm for 50:50 ratio. It can be concluded then that the CeNPs particle size and its content on the composite have an effect on the conductivity of the sensor.

Effect of CeNPs Particle Size on the Detection of Hydroxyl Radicals

There is a direct correlation between the particle size and the amount of Ce³⁺ that control the ●OH scavenging capacity of CeNPs. The density of Ce³⁺ increases as the particle size decreases, which results in more reaction between CeNPs and ●OH radicals. Furthermore, a small particle size possesses a larger surface area to contact and react with ●OH radicals. The size of the CeNPs has a significant impact on the sensor performance for the detection of ●OH radicals. While there is no redox reaction observed in the presence of H₂O₂ solution, there are redox peaks in the presence of ●OH radicals. The redox curves are the result of the reaction of Ce³⁺ on the surface of the CeNPs with the ●OH radicals as described in FIG. 1. This confirms the ability of the CeNPs/GO-LTS composite-modified electrode to react with ●OH radicals, whereas it shows no distinguishable redox peaks with H₂O₂.

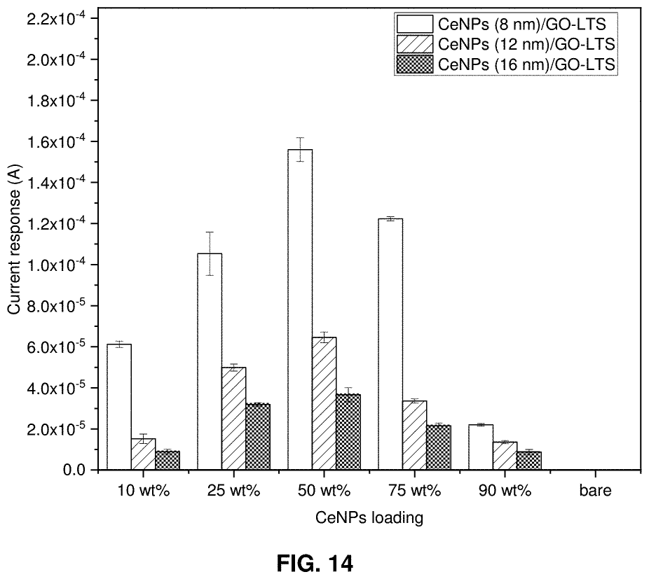

FIG. 14 clearly shows that 8 nm CeNPs provides the largest current change (ΔA) due to the redox reaction regardless of the CeNPs loading used in the composite. The redox response increases as the size of CeNPs decreases for all the CeNPs loadings tested except for 90 wt %. The effect of the CeNPs loading in the composite on the redox response is further explained below. The experimental results, thus, verify that the CeNPs size has a great impact on the sensor performance for the detection of ●OH radicals. This is due to the fact that smaller particles have a higher surface area and more Ce³⁺ per unit particle mass, which are the active sites for the reaction with ●OH free radicals.

Effect of CeNPs Loading on the Detection of Hydroxyl Radicals

The sensor response for ●OH detection not only depends on the particle size of CeNPs, but also the amount of CeNPs on the CeNPs/GO-LTS composite. Consequently, the CeNPs loading in the composite was further examined. CeNPs loadings of 10, 25, 50, 75, and 90 wt % were used to make the composites. FIG. 14 demonstrates that the amount of CeNPs used in the composite greatly affected the sensor response to ●OH radicals. The current change increases with the addition of CeNPs until reaching a maximum at 50 wt % CeNPs loading. The current change decreases for CeNPs loadings higher than 50 wt %. The three different sizes of CeNPs (namely, 8, 12, and 16 nm) used in this example show a similar response for all CeNPs loadings. Since the CeNPs/GO-LTS composite-modified electrode in FIG. 14 was tested in the Fenton reaction for the detection of ●OH radicals, the sensor response depended on the amount of both CeNPs and GO. As mentioned earlier, the CeNPs were used as the sensing element and GO was used to improve the conductivity of the composite. On the other hand, as shown in FIG. 13, the CeNPs/GO-LTS composite-modified electrode was tested in the solution of [Fe(CN)₆]^{3-/4-} as electrolyte without generating ●OH radicals. Thus, the content of GO is an important factor controlling the sensor response.

The results in FIG. 14 confirm that the CeNPs size and loading play important roles in the detection of ●OH radicals. As stated above, even though CeNPs contain redox-active sites, i.e., Ce³⁺, their low conductivity generally makes them a poor choice as a sensing device. However, the integration with GO successfully achieved high dispersion of the nanoparticles with increased overall conductivity as shown in FIGS. 12-13. Interestingly, in FIG. 14, although the sensor response increases with the addition of CeNPs until getting a maximum at 50 wt % CeNPs loading for all different sizes, 8 nm CeNPs shows a much higher sensor response compared to 12 and 16 nm. When the CeNPs loading increases from 25 to 50 wt %, 8 nm CeNPs show a 1.8-times increase of sensor response as compared to 1.3 times and 1.2 times for 12 and 16 nm, respectively. Without wishing to be bound by theory, it is believed that this is due to the remarkable increase of Ce³⁺ active sites from the addition of 8 nm CeNPs into the composite. However, 12 and 16 nm are not shown to be the equivalent degree for the increase of sensor response. This may be due to the fact that 12 and 16 nm CeNPs possess a small amount of Ce³⁺ on its surface. Even though the CeNPs loading increases from 25 to 50 wt %, there is not a significant increase of Ce³⁺ on the composite inducing in a small degree for the increase of sensor response.

The composites with low CeNPs loadings (10 and 25 wt %) produced smaller responses compared to the 50 wt % loading, even though the conductivity of the composites were high because of the large contents of GO. The lack of Ce³⁺ sites when using 10 and 25 wt % of CeNPs caused low responses for the detection of ●OH radicals. When the CeNPs loading increased to 75 and 90 wt %, the redox responses became lower than the one with 50 wt % CeNPs, which is due to the lower conductivities of small amounts of GO. For the CeNPs loadings of 10, 25, 50, and 75 wt %, AA of CeNPs (8 nm)/GO-LTS is 4.0, 2.4, 2.5, and 3.7 times greater than CeNPs (12 nm)/GO-LTS, and 7.0, 3.3, 4.3, and 5.7 times greater than CeNPs (16 nm)/GO-LTS composites, respectively. However, the sensor response of CeNPs (8 nm)/GO-LTS with 90 wt % CeNPs loading shows a dramatic decrease from that with 75 wt % CeNPsOₓ, and it is only 1.5 and 2.0 times greater than those of CeNPs (12 nm)/GO-LTS and CeNPs (16 nm)/GO-LTS, which is much different from the other loadings. This result indicates that the 8 nm composite may have other factors influencing the decrease of the sensor response at high CeNPs loadings such as 90 wt %. The aggregation of 8 nm CeNPs occurred at high contents, resulting in the decrease of both the overall surface area and the amount of Ce³⁺ available for ●OH radical detection. By having less surface area and smaller number of Ce³⁺ sites, the current response of 90 wt % CeNPs (8 nm)/GO-LTS is considerably decreased and slightly higher than 90 wt % CeNPs (12 nm)/GO-LTS and 90 wt % CeNPs (16 nm)/GO-LTS. Furthermore, the electron transfer between the active sites and the electrode surface may be retarded by the aggregation of CeNPs. The largest sensor response was obtained with the 50 wt % CeNPs (8 nm)/GO-LTS composite. With an equal content of CeNPs and GO, CeNPs are homogeneously dispersed onto the surface of GO with less aggregation, which results in a great number and exposure of Ce³⁺ for reaction with ●OH radicals. In summary, the size of CeNPs and the ratio of CeNPs and GO in the composite were successfully controlled to optimize the sensor response to ●OH radicals.

Composite Sensitivity Toward Hydroxyl Radicals

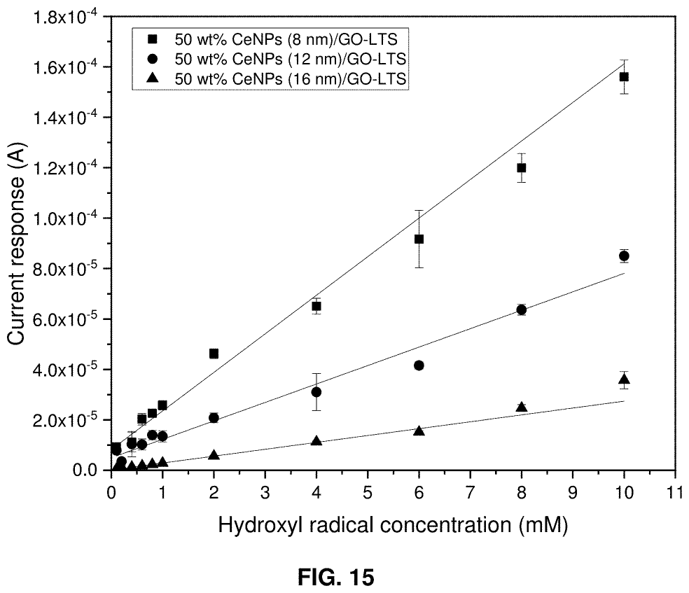

Three 50 wt % CeNPs/GO-LTS composite sensors with different CeNPs particle sizes of 8, 12, and 16 nm were used to determine the limit of detection (LOD) of ●OH radicals. The concentration of ●OH radicals was varied between 0.1 and 10 mM. Regardless of the size of the CeNPs used in the test, the composite sensor shows a linear relationship between the sensor current response and the concentration of ●OH radicals, as shown in FIG. 15. It also shows that the CeNPs particle size has a significant impact on the sensor response to different ●OH radical concentrations. The 50 wt % CeNPs (8 nm)/GO-LTS composite shows the largest current response when compared to those with 12 and 16 nm CeNPs for all the tested ●OH radical concentrations. The equation (3.3×SD)/b was used to determine the limit of detection (LOD), where SD represents the standard deviation of the blank and b is the slope of the regression line. The detection limit was found to be lowered when smaller CeNPs were used as 8, 12, 16 nm CeNPs resulted in 0.085, 0.18, and 0.47 mM of LODs, respectively. Again, this result confirms the impact of the CeNPs size on the sensor efficiency toward the detection of ●OH radicals.

Conclusions

A CeNPs/GO composite electrochemical sensor was investigated for the detection of ●OH radicals. The particle size and content of CeNPs in the composite was shown to control the sensor response to ●OH radicals. An electrode modified with a 50 wt % CeNPs (8 nm)/GO-LTS composite showed the largest sensor response toward ●OH radicals with the lowest detection limit of 0.085 mM. The smaller the size of CeNPs was, the greater the current change that was produced from the redox reaction for all the CeNPs loadings tested. The 50 wt % CeNPs loading in the composites showed the largest responses for all the tested CeNP sizes. The current response decreased when the content of CeNPs was higher than 50 wt % because of the low conductivity of the composite resulted from the low content of GO. The dramatic decrease of the sensor response when using 90 wt % CeNPs (8 nm)/GO-LTS is believed to be due to the aggregation of CeNPs. In sum, this example verifies the use of the CeNPs/GO-LTS composite for its ability as an effective sensing element for ●OH radical detection. The composite can be used for real-time mediatorless sensors for medical diagnosis, environmental and food sample analyses, and any area where hydroxyl radicals are to be used or controlled.

### Example II—Supersensitive Sensor for the Detection of Hydroxyl Free Radicals

Materials and Methods

Tris(cyclopentadienyl)cerium(III) (99.9% Ce) was purchased from Strem Chemicals, Inc. Vulcan XCmax 22 and tetrahydrofuran (99.9%) were obtained from Cabot Corporation and ACROS Organics, respectively. Potassium hexacyanoferrate(II) trihydrate (98.5-102.0%), potassium hexacyanoferrate(III) (>99%), iron(III) chloride (97%), iron(II) sulfate heptahydrate (99%), and 30 wt % hydrogen peroxide solution were obtained from Sigma-Aldrich. Screen-printed carbon electrodes (Pine Instruments) were used as the sensor base with 2 mm of working electrodes. The size and the presence of CeNPs were determined by scanning transmission electron microscopy (STEM) using a Titan 60-300 STEM. The amount of CeNPs loading was determined by Inductively Coupled Plasma-Mass Spectrometry (ICP-MS) at Galbraith Laboratories. The ratio of Ce³⁺ and Ce⁴⁺ on CeNPs was obtained using a Kratos Axis Ultra XPS with a monochromatic Al X-ray source operating at 10 mA and 15 kV. Cyclic voltammetry (CV) was performed using a Gamry Reference 600 potentiostatic (Gamry Instruments, USA).

Acid-Treatment of Vulcan Carbon and Graphene Oxide

Superconductive Vulcan XCmax 22 carbon (a highly conductive amorphous carbon, more conductive than graphene oxide) was treated with a 5 M HNO₃ aqueous solution under reflux for 6 h to functionalize the surface with carboxylic groups. After that, the acid-treated Vulcan carbon was filtered and washed with deionized water until the pH was around 7. Then, the acid-treated Vulcan carbon was dried in an oven at 60° C. for 12 h. The same protocol was used to functionalize the surface of graphene oxide.

Surface Organometallic Grafting (SOG) of Cerium Oxide Nanoparticles onto Acid-Treated Vulcan Carbon (C) and Acid-Treated Graphene Oxide (GO)

Prior to the synthesis of the CeNPs/C-SOG material, the acid-treated Vulcan carbon was dried at 105° C. under vacuum for 24 h. Then, CeNPs were added by surface organometallic grafting (SOG). A calculated mass of tris(cyclopentadienyl)cerium(III) (cerium precursor) was dissolved in tetrahydrofuran (THF) under inert atmosphere. This solution was then added to the dried acid-treated Vulcan carbon and stirred under inert atmosphere until total uptake (color disappearance). After 6 h of stirring, the flask was connected to a Schlenk line to remove THF. Subsequently, the dried solid product was treated at 400° C. for 2 h under flow of inert for ligands removal. Finally, the product was collected and used later as the sensing element for the detection of hydroxyl radicals. The same protocol was used to synthesize CeNPs/GO-SOG composites.

Deposition of the CeNPs/C-SOG and CeNPs/GO-SOG Materials onto the Glassy Carbon Electrode

10 mg of the CeNPs/C-SOG sample was suspended in 10 mL of deionized water. The solution was then sonicated for 1 h and deposited onto the working electrode by delivering a single drop (8 μL) using a micropipette. The droplet was dried in an oven at 60° C. for 1 h. Once dried, the sensor was rinsed with deionized water and dried by gently flowing nitrogen gas. The same protocol was used for the deposition of CeNPs/GO-SOG onto the glassy carbon electrode. Both the CeNPs/C-SOG and CeNPs/GO-SOG modified electrodes were used for the detection of hydroxyl free radicals (●OH radicals) in the Fenton reaction.

Detection of Hydroxyl Free Radicals (●OH Radicals) by the CeNPs/C-SOG-Modified Electrode and the CeNPs/GO-SOG-Modified Electrode

The Fenton reaction was used to generate ●OH radicals. Equal volumes of a 10 mM solution of H₂O₂ and FeSO₄.7H₂O were used to generate ●OH radicals via the reduction of H₂O₂ in the presence of Fe²⁺ ions. The CeNPs/C-SOG-modified electrode was put into the Fenton reaction for the detection of ●OH radicals by cyclic voltammetry (CV). The first cycle of CV was carried out using the H₂O₂ solution. After that, the electrode was removed from the solution, and then an equal volume of the iron (II) sulfate solution was added to generate ●OH radicals. Then, the electrode was immersed in the mixing solution of H₂O₂ and FeSO₄.7H₂O to detect ●OH radicals. The current change from the modified electrode before and after generating ●OH radicals was measured and referred to the presence of ●OH radicals. The same procedure was followed to measure the presence of ●OH radicals with CeNPs/GO-SOG composites.

Results

Fourier Transform Infrared Spectroscopy

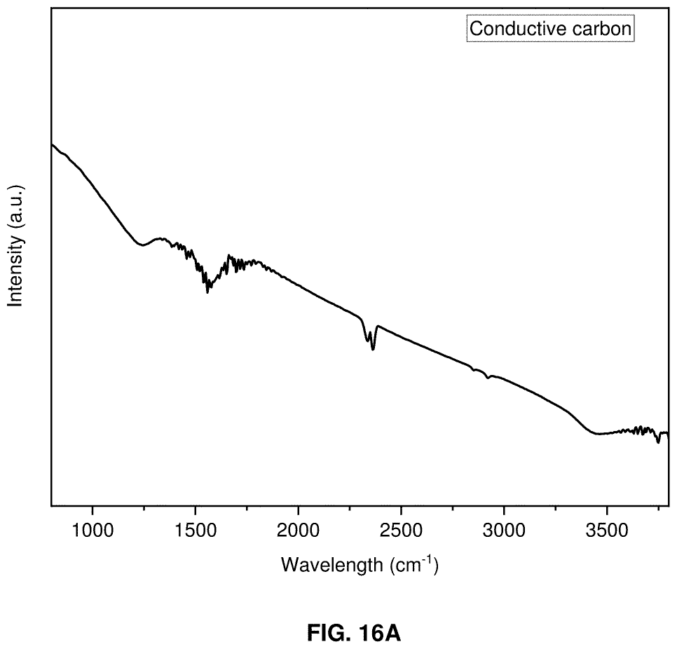

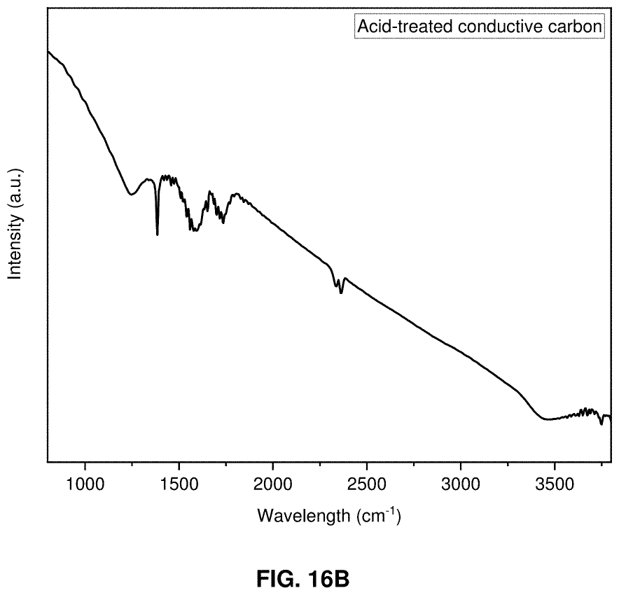

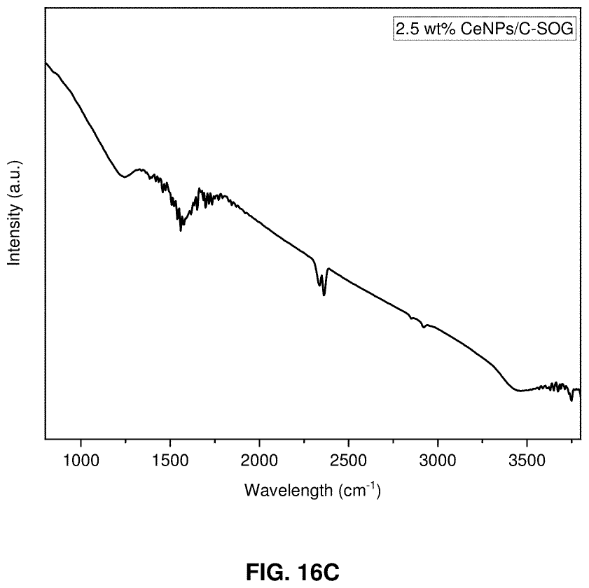

Fourier Transform Infrared (FTIR) spectroscopy measurements were used to characterize the carbon support before and after the functionalization and deposition of cerium oxide nanoparticles (CeNPs) on its surface. FIGS. 16A-16C show the FTIR spectra for Vulcan XCmax 22 conductive carbon (FIG. 16A), acid-treated Vulcan XCmax 22 conductive carbon (FIG. 16B), and 2.5 wt % CeNPs/C-SOG (FIG. 16C). The bands of interest in the acid-treated conductive carbon are at 1230 and 1735 cm⁻¹, which represent the C—O and C═O stretching frequencies, respectively. The presence of those bands in FIG. 16B when compared to FIG. 16A confirms the successful creation of carboxylic functional group (—COOH) on the surface of the conductive carbon. Carboxylic groups are generated as reactive sites for the anchorage of the cerium precursor onto the surface of carbon. The effective bonding of the cerium precursor to the surface of the acid-treated conductive carbon can be confirmed by the significant intensity decrease of the bands at 1230 and 1735 cm⁻¹ in FIG. 16C when compared to FIG. 16B. Thus, from FTIR results, it can be concluded that the anchorage of the cerium oxide nanoparticles onto the conductive carbon was successful, being able to use this material as the sensing element for hydroxyl radical detection.

Thermogravimetric Analysis (TGA)

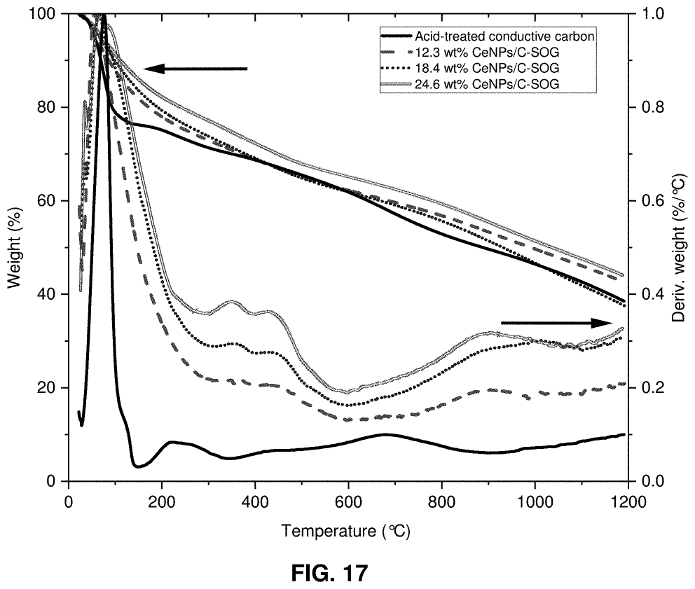

The TGA profile of acid-treated conductive carbon was compared to those of the CeNPs/C-SOG composites with 12.3, 18.4, and 24.6 wt % CeNPs in FIG. 17. The acid-treated conductive carbon shows two main weight losses at around 100° C. and 200-300° C., which represent the evolutions of water and functional groups on the surface of the conductive carbon, respectively. On the other hand, when the cerium precursor is anchored to the carbon surface (without further thermal treatment in inert), there are four significant weight losses, which are at around 100, 300-400, 400-500, and 700-1100° C. First, the weight loss at around 100° C. shows the presence of water on the conductive carbon. Second, the weight loss at 300-400° C. represents the cerium precursor physically adsorbed onto the surface of conductive carbon. Third, the weight loss at 400-500° C. demonstrates the removal of the ligands of the cerium precursor. Last, the weight loss at 700-1100° C. is assigned to the breakage of the chemical bonding between CeNPs on the surface and Vulcan carbon. Moreover, the peak areas increase with the amount of CeNPs added. Therefore, TGA results also confirm the presence of CeNPs on the surface of conductive carbon.

Inductively Coupled Plasma-Mass Spectrometry (ICP-MS)

The actual content of CeNPs on the conductive carbon was determined by ICP-MS analysis as shown in Table 1. The Ce wt % loading increased with the amount of cerium precursor used in the synthesis. However, the more cerium precursor is used in the synthesis, the less efficient is the immobilization of CeNPs on the conductive carbon. For example, when the theoretical Ce loading was 30 wt %, that resulted on 20.8 wt % of Ce on carbon (by ICP-MS). Without wishing to be bound by theory, it is believed that this is due to the saturation of the carbon surface by the cerium precursor. Thus, the ICP-MS results also confirm the presence of CeNPs on the conductive carbon.

TABLE 1
Ce wt % loading determined by ICP-MS

| | Theoretical Ce | Actual Ce |
|---|---|---|
| Sample | loading (wt %) | loading (wt %) |
| 2.5 wt % CeNPs/C-SOG | 2.0 | 3.3 |
| 18.4 wt % CeNPs/C-SOG | 15.0 | 13.5 |
| 36.9 wt % CeNPs/C-SOG | 30.0 | 20.8 |

X-Ray Photoelectron Spectroscopy (XPS)

X-ray photoelectron spectroscopy (XPS) is a useful technique to determine the content of Ce³⁺ and Ce⁴⁺ sites in the samples (Table 2). The amount of Ce³⁺ sites increases with the decrease of the CeNPs loading. The 2.5 wt % CeNPs/C-SOG sample shows the highest content of Ce³⁺. The size of the CeNPs on 2.5 wt % CeNPs/C-SOG is smaller than on the 36.9 wt % CeNPs/C-SOG, which explains the different Ce³⁺/Ce⁴⁺ ratios. According to the XPS results, small CeNPs loadings provide the most suitable materials for the detection of hydroxyl free radicals.

TABLE 2
Amount of Ce³⁺ and Ce⁴⁺ sites as a function of the CeNPs loading

| Sample | % Ce(III) | % Ce(IV) |
|---|---|---|
| 2.5 wt % CeNPs/C-SOG | 43.42 | 56.58 |
| 18.4 wt % CeNPs/C-SOG | 42.52 | 57.48 |
| 36.9 wt % CeNPs/C-SOG | 28.96 | 71.04 |

Scanning Transmission Electron Microscopy (STEM)

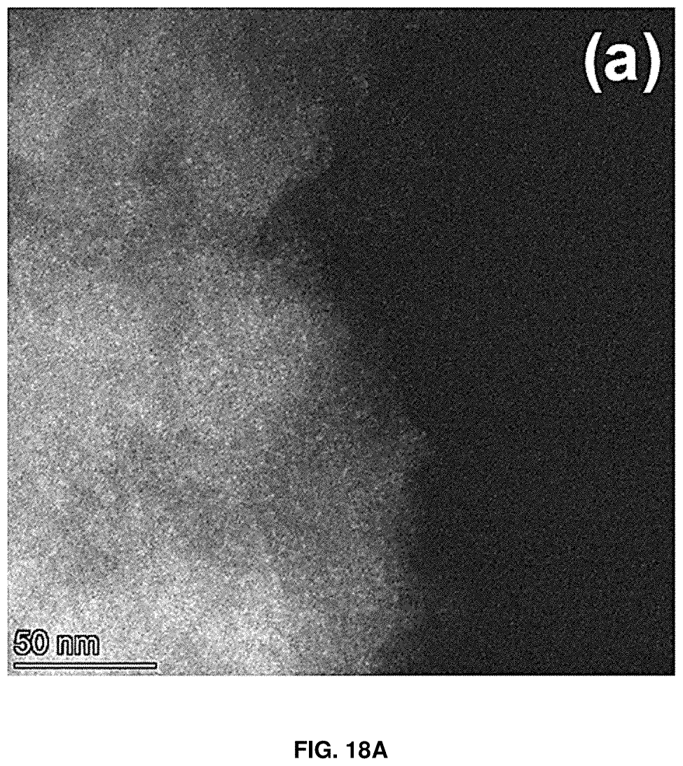

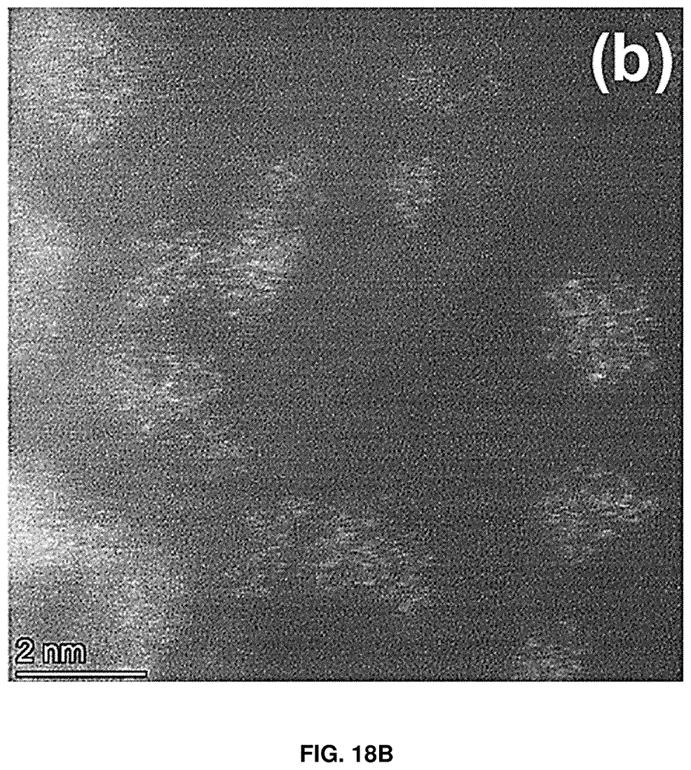

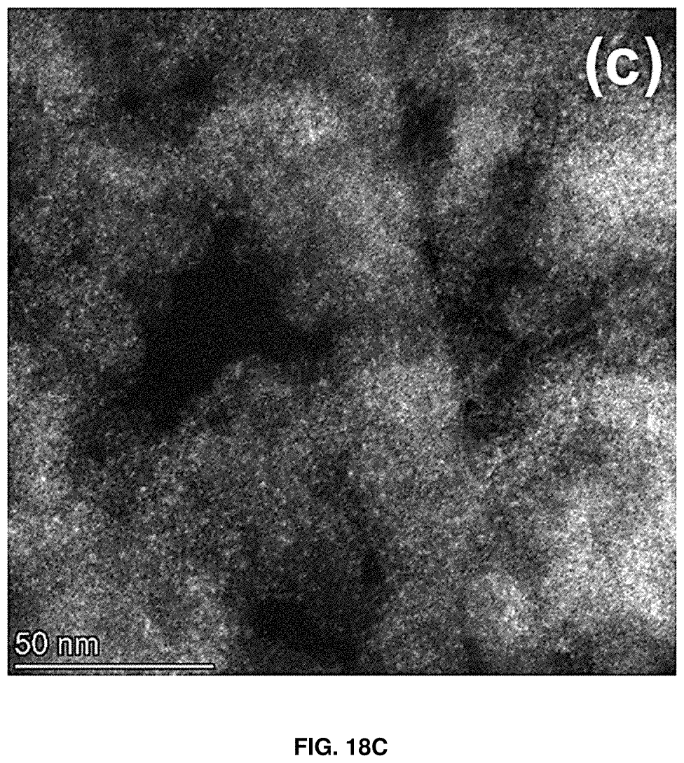

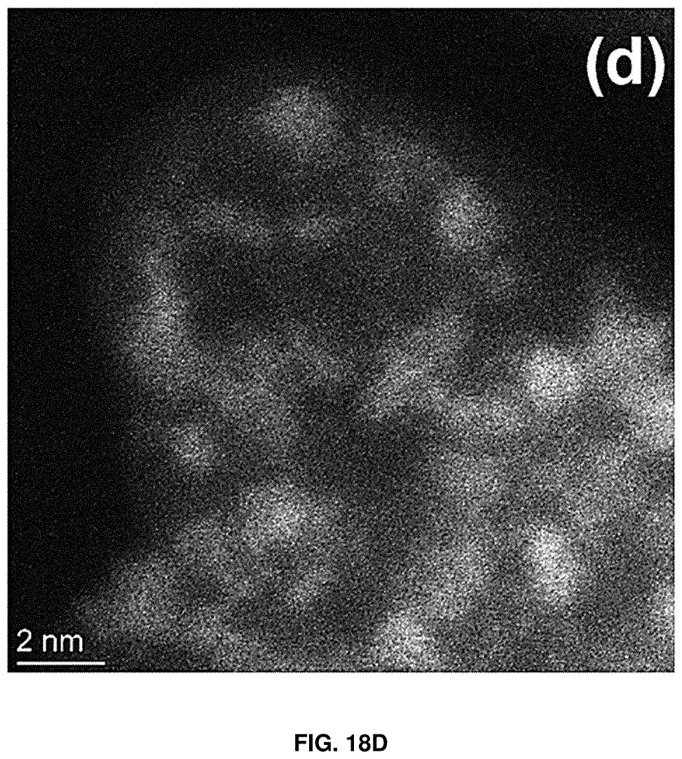

FIGS. 18A-18D show STEM images of CeNPs on conductive carbon. For both 2.5 wt % CeNPs/C-SOG (FIGS. 18A-18B) and 18.4 wt % CeNPs/C-SOG (FIGS. 18C-18D), there is a homogeneous distribution of the CeNPs on carbon. However, there is a significant difference between 2.5 wt % and 18.4 wt % CeNPs/C-SOG in terms of the degree of agglomeration of CeNPs on the carbon surface, where the CeNPs are smaller at lower loadings (2.5 wt % CeNPs/C-SOG). On the other hand, there is a high degree of agglomeration in 18.4 wt % CeNPs/C-SOG (FIG. 18D). Therefore, from STEM images, the presence of CeNPs on the carbon surface and the effect of the CeNPs loading on the particle size are confirmed.

The Effect of the CeNPs Loading on the Sensor Efficiency for Hydroxyl Radical Detection

FIG. 19A shows the effect of the CeNPs loading on the sensor response to hydroxyl radicals. 18.4 wt % CeNPs/C-SOG showed the highest sensor response to hydroxyl radicals, and this is likely due to the combination of a high number of Ce³⁺ and high loading. Higher loadings of CeNPs (24.6 wt % CeNPs/C-SOG) likely result in high agglomeration and reduced activity. Notably, even though 2.5 wt % and 18.4 wt % CeNPs/C-SOG have similar concentration of Ce³⁺ in the nanocomposite, 18.4 wt % gives a much higher sensor response compared to 2.5 wt %. This is because the 18.4 wt % sample has a much larger number of reactive sites to interact with hydroxyl radicals due to its higher loading. However, the efficiency of the sensor for the detection of hydroxyl free radicals should be measured as the sensor response per gram of CeNPs (FIG. 19B). From FIG. 19B, it can be concluded that lower loadings (1.2 wt % CeNPs/C-SOG) provide a higher efficiency for the detection of free radicals. Loadings <1.2 wt % CeNPs can provide even better results, as the CeNPs are even more disperse with a high concentration of Ce³⁺ sites.

The Effect of the Synthesis Method on the Sensor Response to Hydroxyl Free Radical

Table 3 shows that the highest sensor response to hydroxyl radical is obtained with the CeNPs/C-SOG nanocomposites synthesized by surface organometallic grafting (SOG). When compared to a previous method that used Prussian Blue (PB) (described in US 2019/0212286 A1, incorporated herein by reference for all purposes), the current synthesis method improves the sensor response by two orders of magnitude. The sensor response is also an order of magnitude higher than that obtained by the deposition of 8 nm CeNPs nanoparticles on graphene oxide by the low-temperature solution process (CeNPs/GO-LTS). The significant enhancement of the sensor response is due to the ultra-small CeNPs size (˜2 nm), which possess a high content of Ce³⁺ sites for the detection of hydroxyl free radicals.

TABLE 3
The effect of the synthesis method on the sensor
efficiency for hydroxyl free radical detection

| | Current response/mass |
|---|---|
| Synthesis method | of CeNPs (A/g_{CeNPs}) |
| Composite modified with | 2.7 × 10⁻⁵ |
| Prussian Blue (described | |
| in US 2019/0212286 A1) | |
| Low-temperature solution | 3.1 × 10⁻⁴ |
| process (CeNPs (8 nm)/GO-LTS) | |
| Surface organometallic | 6.4 × 10⁻³ |
| grafting (2.5 wt % CeNPs/C-SOG) | |

### Example III—Comparisons

A comparison of CeNPs/C-SOG and CeNPs/GO-SOG synthesized from surface organometallic grafting was conducted. FIGS. 20A-20D show the results without (FIGS. 20A-20B) and with (FIGS. 20C-20D) normalization per mass of CeNPs used.

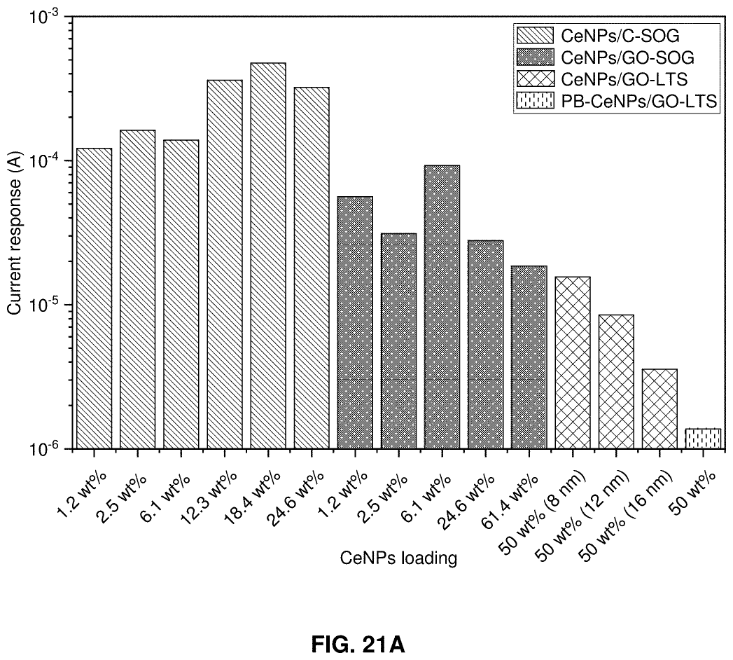

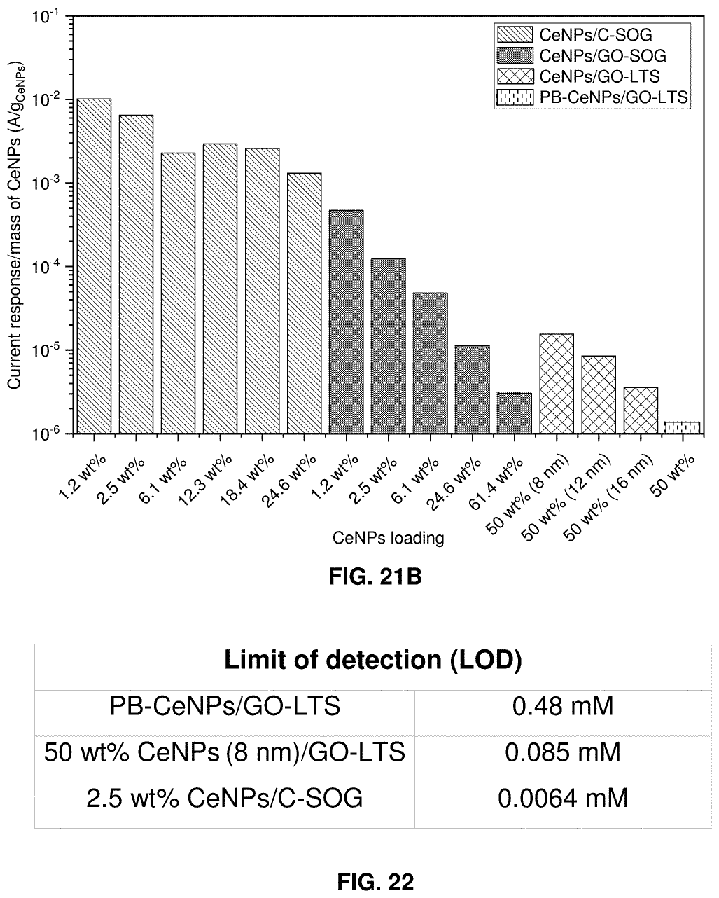

A comparison of CeNPs/C-SOG and CeNPs/GO-SOG synthesized from surface organometallic grafting, CeNPs/GO-LTS synthesized from the low-temperature solution process, and Prussian blue-CeNPs/GO-LTS composite was conducted. FIGS. 21A-21B show the results, without (FIG. 21A) and with (FIG. 21B) normalization per mass of CeNPs used.

FIG. 22 shows Table 4, displaying the limit of detection (LOD) of each of the three types of sensors. As seen in FIG. 22, the CeNPs/C-SOG sensor showed significantly better response than both the CeNPs/GO-LTS sensor and the PB-CeNPs/GO-LTS sensor.

Cerium oxide was also doped directly on a glassy carbon electrode (which is made of amorphous carbon without modification). The ●OH radical sensing from the resulting product was not good.

Certain embodiments of the compositions, devices, and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions, devices, and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A composition comprising:
a carbon-based substrate; and
cerium oxide nanoparticles on the carbon-based substrate, wherein the carbon-based substrate comprises a conductive, amorphous carbon.

2. The composition of claim 1, wherein the cerium oxide nanoparticles are present in an amount ranging from about 1% by weight to about 60% by weight; about 2% by weight to about 30% by weight; or from about 3% by weight to about 15% by weight

3. The composition of claim 1, wherein the conductive, amorphous carbon comprises a functionalized surface, wherein the functionalized surface comprises carboxyl groups.

4. The composition of claim 1, wherein cerium oxide nanoparticles are either chemically bonded to the conductive amorphous carbon substrate, or are directly on the conductive amorphous carbon substrate.

5. The composition of claim 1, wherein the composition does not include Prussian blue; and or/wherein the carbon-based substrate does not include graphene or graphene oxide.

6. The composition of claim 1, wherein the cerium oxide nanoparticles comprise: a ratio of Ce³⁺ to Ce⁴⁺ of at least 30:70; a ratio of Ce³⁺ to Ce⁴⁺ of at least 40:60; or, a ratio of Ce³⁺ to Ce⁴⁺ of at least 50:50.

7. A filter for scavenging radicals comprising the composition of claim 1.

8. The filter of claim 7, wherein the composition is embedded within a membrane.

9. The filter of claim 8, wherein the membrane comprises a polymer electrolyte membrane (PEM); optionally, wherein the membrane comprises polytetrafluoroethylene, polytetrafluoroethylene-chlorotrifluoro, ethylene copolymer, polychlorotrifluoroethylene, polybromotrifluoroethylene, polytetrafluoroethylene-bromotrifluoroethylene copolymer, polytetrafluoroethylene-perfluorovinyl ether copolymer, polytetrafluoroethylene-hexafluoropropylene, or copolymers thereof.

10. A sensor comprising:
an electrode;
a carbon-based substrate on the electrode; and
cerium oxide nanoparticles directly on the carbon-based substrate;
wherein the cerium oxide nanoparticles comprise a ratio of cerium (III) to cerium (IV) of at least 0.4.

11. The sensor of claim 10, wherein the carbon-based substrate comprises a conductive, amorphous carbon.

12. The sensor of claim 10, wherein the cerium oxide nanoparticles have an average size of about 3 nm.

13. The sensor of claim 10, comprising a weight ratio of cerium oxide nanoparticles to graphene oxide ranging from: about 10:90 to about 90:10; optionally about 25:75; about 50:50; or, about 75:25.

14. The sensor of claim 10, wherein the electrode comprises:
an elongated body having a proximal end and a distal end;
a sensing area at the distal end, wherein the sensing area comprises a working electrode and a counter electrode, wherein the working electrode comprises a sensing composition configured to detect free radicals;
at least two curved ridges extending a distance beyond the elongated body to at least partially encircle the sensing area; and
an opening between the at least two curved ridges, wherein the opening is configured to permit a fluid to flow into the sensing area while the curved ridges are contacting a surface.

15. A method for scavenging radicals, the method comprising:
detecting free radicals with a sensing composition comprising cerium oxide nanoparticles on a carbon-based substrate, wherein the carbon-based substrate comprises a conductive, amorphous carbon.

16. The method of claim 15, wherein the cerium oxide nanoparticles are directly on the carbon-based substrate.

17. A method for making the composition of claim 1, the method comprising:
acid-treating a conductive, amorphous carbon to create a functionalized surface on acid-treated amorphous carbon;
contacting the functionalized surface with a solution comprising a cerium oxide precursor to organometallically graft the cerium oxide precursor onto the functionalized surface and create a grafted surface;
removing solvent from the grafted surface to produce a product;
drying the product to produce a free radical sensing composition; and
conducting a thermal treatment in inert to remove the precursor ligands.

18. The method of claim 17, wherein the cerium oxide precursor comprises tris(cyclopentadienyl)cerium(III).

19. The method of claim 17, further comprising drying the acid-treated amorphous carbon under vacuum prior to contacting the functionalized surface with the solution.

20. The method of claim 17, wherein the contacting is conducted in an inert atmosphere.
